(19) United States
(12) Patent Application Publication
(10) Pub. No.: US 2026/0290007 A1
(43) Pub. Date: Sep. 24, 2026

(54) SYSTEM

(71) Applicant: SoftBank Group Corp., Tokyo (JP)

(72) Inventor: Shiho ONO, Tokyo (JP)

(73) Assignee: SoftBank Group Corp., Tokyo (JP)

(21) Appl. No.: 19/567,454

(22) Filed: Mar. 16, 2026

(30) Foreign Application Priority Data
Mar. 19, 2025 (JP) 2025-045032

(51) Int. Cl. G06V 20/20; G06V 10/25; G06V 10/764; G06V 10/82

(52) U.S. Cl. CPC G06V 20/20; G06V 10/25; G06V 10/764; G06V 10/82

(57) ABSTRACT

A system includes a processor that is configured to obtain a product image, analyze the obtained product image to identify one or more product characteristics of a product shown in the product image, generate a prompt sentence configured to instruct a generative AI model to propose an optimal packaging method based on the identified one or more product characteristics, input the generated prompt sentence into the generative AI model, select recommended packaging materials based on a packaging method proposed by the generative AI model, enable purchase of the selected packaging materials through an electronic commerce platform, generate a guide for implementing a safe packaging method using the purchased packaging materials, and transmit the generated guide to a terminal of a user.

### CROSS-REFERENCE TO RELATED APPLICATION

This application is based on and claims priority under 35 USC 119 from Japanese Patent Application No. 2025-045032 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, individual users and small businesses frequently sell and ship products through various electronic commerce platforms. However, many users do not possess sufficient expertise regarding appropriate packaging methods and packaging materials for different types of products. As a result, products are often packaged inadequately, leading to damage during transportation, increased return and replacement costs, and reduced customer satisfaction. Furthermore, the selection of packaging materials is typically left to the user, who must manually search among a large number of packaging items and sets. This manual selection process is time-consuming and error-prone, and the user may choose packaging materials that are inappropriate in view of the size, fragility, material, or category of the product. In addition, although generative AI models have recently become capable of generating detailed instructions and recommendations, conventional systems do not effectively utilize product images and product-specific characteristics to generate optimized packaging methods and corresponding purchasing guidance in an integrated manner. Conventional approaches also lack a mechanism for iteratively improving prompts and recommendations based on user feedback, which limits the personalization and reliability of the generated packaging guidance. Accordingly, there is a need for a system that can automatically analyze an image of a product, identify product characteristics, generate an optimal packaging method using a generative AI model, select suitable packaging materials available via electronic commerce platforms, and provide a user with a concrete guide for safely implementing the recommended packaging method, while also enabling refinement of the generative AI prompts based on user feedback.

### SUMMARY

To solve the above-described problems, the present invention provides a system comprising a processor configured to perform a series of operations extending from image analysis of a product to generation and provision of a packaging guide.

The processor is configured to obtain a product image and analyze the obtained product image to identify one or more product characteristics of a product shown in the product image. The identified product characteristics may include, for example, size, shape, material, fragility, or product category. Based on the identified one or more product characteristics, the processor generates a prompt sentence that is configured to instruct a generative AI model to propose an optimal packaging method appropriate for the product. The processor then inputs the generated prompt sentence into the generative AI model so that the generative AI model generates a proposal of the optimal packaging method.

The processor is further configured to select recommended packaging materials based on a packaging method proposed by the generative AI model. In particular, the processor may map elements of the proposed packaging method, such as required box size, cushioning type, adhesive tape type, and labeling, to specific products or product sets available on an electronic commerce platform. The processor enables purchase of the selected packaging materials through the electronic commerce platform by, for example, generating purchase links, shopping cart data, or API calls that connect the user to the electronic commerce platform.

After the purchase is completed or when appropriate, the processor generates a guide for implementing a safe packaging method using the purchased packaging materials. The guide may include step-by-step instructions, images, diagrams, or video information that concretely explain how to carry out the proposed packaging method. The processor then transmits the generated guide to a terminal of a user so that the user can easily follow the instructions and perform safe packaging.

In some embodiments, the processor is further configured to cause the generative AI model to receive feedback from the user and adjust the prompt sentence based on the feedback in order to maximize convenience and satisfaction of the user. Moreover, the processor may generate the prompt sentence such that the prompt sentence includes details of the one or more product characteristics when the generative AI model proposes the optimal packaging method, thereby enabling the generative AI model to generate more accurate and product-specific packaging recommendations. Through these means, the system of the present invention can automatically provide optimized packaging methods and material selections tailored to each product and user, thereby reducing damage during shipping and improving user convenience and satisfaction.

The term “product image” refers to a digital image, such as a photograph or scanned image, that visually represents at least one product and is used as input for analysis of characteristics of the product.

The term “product characteristics” refers to attributes of a product that are derived from or associated with a product image, including, for example, size, shape, material, fragility, category, weight, or other physical or functional properties relevant to packaging.

The term “generative AI model” refers to a machine learning model, such as a large language model or multimodal model, that is configured to generate text, images, or other content in response to an input prompt.

The term “prompt sentence” refers to text data, including one or more sentences, phrases, or structured instructions, that is generated for input to a generative AI model in order to cause the generative AI model to output a proposed packaging method or related information.

The term “packaging method” refers to a sequence of operations, steps, or procedures for wrapping, cushioning, enclosing, sealing, and labeling a product for shipment, including specifications for materials and their arrangement.

The term “optimal packaging method” refers to a packaging method that is determined, based on one or more product characteristics, to be suitable for minimizing damage or risk during transportation, while satisfying one or more constraints such as cost, ease of implementation, or material availability.

The term “recommended packaging materials” refers to one or more specific packaging items, such as boxes, cushioning materials, tapes, labels, or protective wraps, that are selected based on a packaging method proposed by a generative AI model.

The term “electronic commerce platform” refers to an online system or service, such as a website or application, that enables searching, selecting, purchasing, and payment processing for products including packaging materials.

The term “guide” refers to information generated for a user that describes how to implement a packaging method, and may include textual instructions, images, diagrams, or video content arranged in a step-by-step or instructional format.

The term “terminal” refers to an electronic device operated by a user, such as a smartphone, tablet, personal computer, or other network-connected device, that is configured to communicate with the system and to present information including the guide.

The term “feedback from the user” refers to information provided by a user, such as evaluations, comments, corrections, preferences, or success/failure reports, that relate to a proposed packaging method, a prompt sentence, packaging materials, or the usability of the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

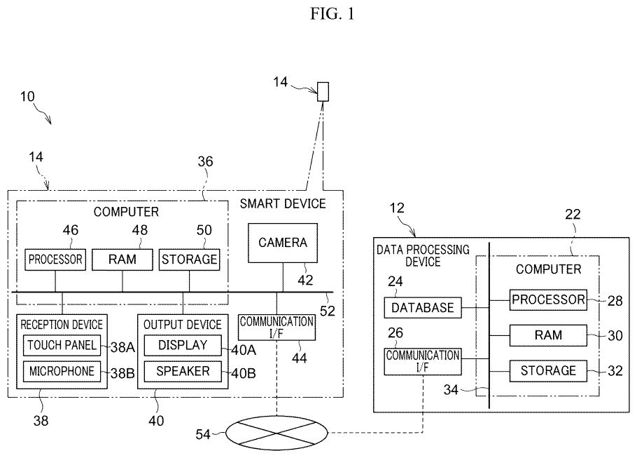

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

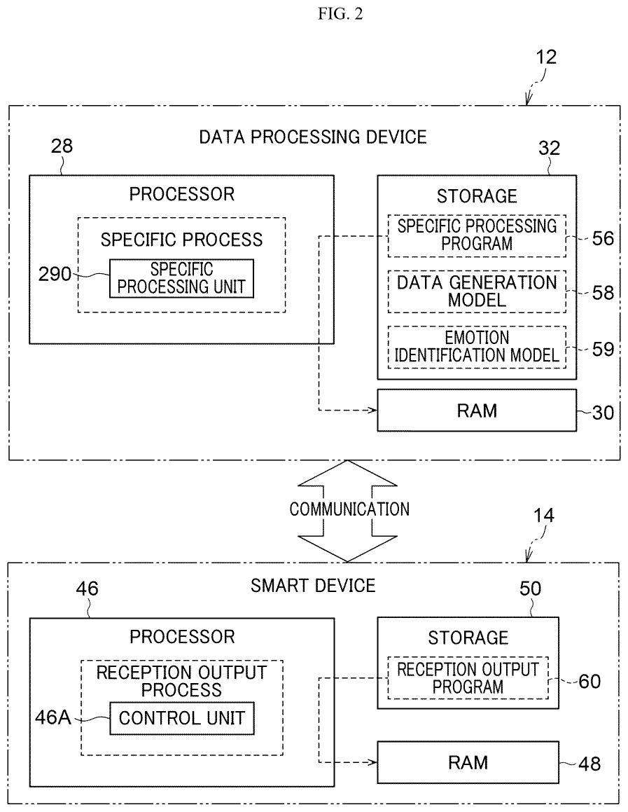

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented packaging support systems are limited to static rule-based logic or manually curated templates that are not able to adapt to the diverse attributes of products and the real-time conditions of electronic commerce platforms. In many known systems, a server merely stores fixed packaging instructions and associates them with coarse product categories. Such an approach fails to leverage detailed product attributes, such as shape, dimension class, mass class, material class, and damage risk level, that can be derived from image analysis and other sensor inputs. As a result, the server cannot algorithmically generate packaging procedures that are optimized for an individual product instance.

In addition, conventional systems do not provide a technically integrated mechanism for coupling machine-based product attribute extraction, generative AI-based packaging procedure synthesis, and automated selection of commercially available packaging materials. Typically, an operator must manually interpret the output of an image recognition engine, manually construct a query for a remote AI model, and then manually search an electronic commerce platform to find compatible packaging materials. This introduces latency, inconsistency, and errors in the end-to-end processing pipeline, and increases processing load on client devices that must handle parts of this workflow.

Moreover, known systems that call a generative AI model tend to treat the model as a black-box text generator, without a structured control flow around prompt sentence construction, output parsing, normalization of generated packaging material information, and mapping of that information to concrete purchase options on external transaction systems. The absence of this structured control leads to unstable results, poor reproducibility, and difficulty in scaling the system to large product catalogs and high traffic, thereby limiting throughput and increasing server-side resource consumption.

Furthermore, existing systems do not adequately exploit the server's capability to automatically generate visual packaging guides, such as instructional videos and annotated images, that are synchronized with AI-generated packaging steps and actually purchased packaging materials. In many cases, static videos are manually produced and are not tailored to specific combinations of product attributes and selected materials. This requires additional human intervention and does not provide a closed-loop, computer-controlled pipeline from product image acquisition to visual guidance delivery.

Accordingly, there is a need for a computer-implemented system in which a server is configured to: (i) automatically acquire product information including product image data from a user terminal; (ii) algorithmically extract and structure detailed product attributes using image processing and machine learning processing units; (iii) programmatically construct and adjust prompt sentences for a generative AI model so that the model outputs machine-usable packaging procedure information and packaging material information; (iv) normalize and classify the packaging material information into packaging material requirement information suitable for automatic querying of electronic transaction systems; and (v) automatically generate, by editing and composing visual information elements, packaging guide information that is synchronized with the AI-generated procedures and the selected packaging materials. Such a system improves the functioning of the server itself by transforming raw multimedia inputs into structured, actionable data, by orchestrating multiple specialized processing components in a deterministic workflow, and by reducing manual intervention and processing redundancy across devices.

The specific processing by the specific processing unit 290 of the data processing device 12 in Example 1 is realized by the following means.

The present invention provides a server comprising a processor configured to acquire product information including product image data from a user terminal via a communication network, analyze the acquired product information to specify attribute information of a product, generate structured data representing the attribute information of the product by using an image processing information processing unit and a machine learning information processing unit, generate a prompt sentence based on the structured data for causing a generative AI model to propose an optimal packaging procedure, input the prompt sentence into the generative AI model and obtain response data including packaging procedure information and packaging material information, analyze and normalize the packaging material information into packaging material requirement information, transmit, based on the packaging material requirement information, a product search request to an electronic transaction system via the communication network and select recommended packaging material candidates from transaction information returned by the electronic transaction system, generate purchase reference information for the recommended packaging material candidates, select visual information elements corresponding to respective steps of a packaging operation based on the packaging procedure information and the recommended packaging material candidates, generate packaging guide information for visually presenting the packaging operation by editing and composing the visual information elements using the image processing information processing unit and a video editing information processing unit, and transmit the packaging guide information and the purchase reference information to the user terminal for presentation on the user terminal. This enables the server to implement an end-to-end, computer-controlled workflow that transforms raw product images into structured product attributes, dynamically constructs and refines prompt sentences for the generative AI model based on those attributes and user-related information, automatically converts model outputs into normalized packaging material requirement information suitable for electronic commerce querying, and programmatically generates synchronized visual packaging guides, thereby improving the technical efficiency, scalability, and reliability of packaging support processing executed by the server.

The term “product information” refers to information related to an item to be packed, including at least image data of the item and optionally additional descriptive data such as textual descriptions, category labels, or user-entered metadata.

The term “product image data” refers to digital image data representing a visual appearance of an item to be packed, including data encoded in standard still image formats or equivalent formats suitable for image processing.

The term “user terminal” refers to an information processing device operated by a user, such as a portable communication device, a computing device, or a display device, that is capable of capturing, transmitting, and receiving data via a communication network.

The term “communication network” refers to a wired or wireless data communication infrastructure, including at least one of a local area network, a wide area network, or a public network, through which the server and the user terminal exchange data.

The term “attribute information of a product” refers to structured or semi-structured information representing characteristics of an item to be packed, including at least one of a product category, shape, dimension class, mass class, material class, or damage risk level.

The term “structured data” refers to data organized in a machine-readable format with explicit fields and values, such as key-value pairs, tables, or object structures, that encode the attribute information of a product for subsequent programmatic processing.

The term “image processing information processing unit” refers to a hardware or software component configured to perform digital image processing operations, including at least one of decoding, resizing, filtering, feature extraction, or other operations on product image data.

The term “machine learning information processing unit” refers to a hardware or software component configured to execute a trained machine learning model, such as a neural network or another statistical model, to infer attribute information of a product from input data including product image data.

The term “generative AI model” refers to a machine learning model configured to generate output data, such as natural language text, based on input information including a prompt sentence, and trained on example data so as to synthesize new content or instructions.

The term “prompt sentence” refers to a natural language or structured textual instruction provided as input to a generative AI model, the instruction specifying at least a context and a requested output format for causing the model to generate packaging procedure information and packaging material information.

The term “packaging procedure information” refers to information describing a sequence of operations for packing an item, including at least step-by-step instructions, ordering of steps, and optional constraints or cautions relevant to safe packing.

The term “packaging material information” refers to information describing materials to be used in packing an item, including at least material types, functions, or general specifications without being limited to any particular commercial product.

The term “packaging material requirement information” refers to normalized and classified information derived from packaging material information, including at least standardized material types, dimensions, quantities, and performance characteristics suitable for use as search conditions in an electronic transaction system.

The term “electronic transaction system” refers to a computer-implemented system that provides access, via a communication network, to transaction information for commercial products or services, and supports at least product search and acquisition of product-related data.

The term “transaction information” refers to information acquired from an electronic transaction system regarding commercial products, including at least identifiers, names, prices, availability, and references to product detail resources.

The term “recommended packaging material candidates” refers to one or more packaging material options selected by the server from products available on an electronic transaction system, the options satisfying at least part of the packaging material requirement information.

The term “purchase reference information” refers to information that enables a user to access and optionally purchase recommended packaging material candidates, including at least references such as resource locators or identifiers for the corresponding products in an electronic transaction system.

The term “visual information elements” refers to discrete visual data components, including at least still images, video segments, graphics, or diagrams, each representing part of a packaging operation or a state of an item or packaging material.

The term “packaging guide information” refers to information for visually presenting a packaging operation to a user, including at least edited and composed visual information elements arranged in temporal or spatial order corresponding to steps of a packaging procedure.

The term “video editing information processing unit” refers to a hardware or software component configured to process and combine multiple visual information elements, including at least cutting, concatenating, overlaying, or encoding operations, to generate a video or other composite media.

The term “user condition information” refers to information indicating preferences or constraints specified by a user, including at least cost preferences, shipping conditions, or handling requirements, which influence the generation of a prompt sentence or packaging procedures.

The term “user evaluation information” refers to feedback information provided by a user regarding the quality, suitability, or effectiveness of packaging procedures, packaging materials, or guides, and used to adjust or refine subsequent prompt sentences or processing.

The term “product category” refers to a classification label indicating a type or class of an item to be packed, such as a general class name or group identifier used for categorizing similar items.

The term “shape” refers to a geometric attribute of a product, representing the external form or outline of the product, such as whether the product is approximately cylindrical, rectangular, or irregular.

The term “dimension class” refers to a categorical representation of the size of a product, such as a classification into discrete ranges like small, medium, or large, derived from measured or estimated physical dimensions.

The term “mass class” refers to a categorical representation of the weight of a product, such as a classification into discrete ranges like light, medium, or heavy, derived from measured or estimated mass.

The term “material class” refers to a categorical representation of the principal material composition of a product, such as a class indicating glass, metal, polymer, ceramic, or another generic material type.

The term “damage risk level” refers to an indication of a likelihood that a product may be damaged during handling or transportation, represented as a categorical level such as low, medium, or high based on inferred or specified fragility.

In one embodiment, a server cooperates with a terminal operated by a user to provide end-to-end packaging support that is technically integrated with image analysis, a generative AI model, and electronic transaction systems. The server includes a processor, a memory, a network interface, and storage. The server executes server-side software implemented, for example, using an operating system, a web server, an application framework, an image processing library, a machine learning framework, a video processing library, and a database management system.

The terminal includes an imaging device, a communication interface, and a display, and executes client-side software such as a native application or a web browser.

The terminal captures product image data using a built-in camera module. The terminal executes camera control software that acquires sensor data from an image sensor, performs basic image signal processing such as demosaicing and white balance, and generates a digital image file in a standard format. The terminal executes an upload module that sends the product image data and optional metadata to the server via a communication network using a secure transport protocol. The server receives the product image data via the network interface and stores the image in a storage subsystem such as a solid-state drive or a network-based object storage. The server uses a web server component to terminate HTTP requests and an application framework, for example a general-purpose server-side framework, to parse request bodies, validate image formats, and register the received data in a database. The server associates the product image data with a user identifier and a session identifier stored in data records.

The server analyzes the product image data by using an image processing information processing unit and a machine learning information processing unit. In one embodiment, the server implements the image processing information processing unit using a software library that provides operations such as color space conversion, image resizing, edge detection, contour extraction, and morphological operations. The server converts the stored image file into an internal matrix representation, resizes the matrix to a predefined spatial resolution, normalizes pixel intensities, and applies edge detection and contour analysis to estimate geometric properties such as aspect ratio, bounding box, and approximate silhouette shape.

The server implements the machine learning information processing unit using a deep learning framework on top of general-purpose processors or graphics processing units. The server loads a pre-trained convolutional neural network that receives the normalized image matrix as input and outputs feature vectors and classification scores. In one embodiment, the convolutional neural network includes multiple convolutional layers with rectified linear activation functions, pooling layers, and fully connected layers at the output. The server defines an output layer that produces probability distributions over product categories and additional regression outputs for size estimates or fragility scores.

The server obtains intermediate feature maps from the convolutional neural network and reduces them to a compact feature vector using global average pooling. The server then maps the feature vector to attribute values such as product category, shape type, dimension class, mass class, material class, and damage risk level. The server uses predetermined thresholds or learned decision boundaries to convert numeric outputs into discrete labels, for example by mapping a continuous fragility score to a damage risk level of low, medium, or high. The server thereby generates structured data representing attribute information of the product in a machine-readable form, such as a record with explicit fields for each attribute.

The server generates a prompt sentence for a generative AI model by combining fixed template strings with the structured data. The server maintains template definitions in a configuration storage, and a prompt generation module reads these definitions and fills placeholders with current attribute values. For example, the server can generate a prompt sentence such as: “You are an expert in shipping and packaging. Based on the following product attributes: category=‘ceramic vase’, fragility=‘high’, size=‘medium’, shape=‘cylindrical’, generate a clear, step-by-step packaging guide for safe shipping. List all required packing materials and tools, and specify approximate quantities.”

In another example, the server can generate a prompt sentence such as: “Analyze the described product attributes and propose an optimal packaging method that minimizes the risk of damage and reduces material cost. Output: (1) a numbered list of packing steps, (2) a bullet list of required packing materials with dimensions, and (3) brief reasons why this method is appropriate.”

The server can further incorporate user condition information and user evaluation information into the prompt sentence. For example, the server can embed additional clauses such as “The user prefers low-cost materials and international air shipping” or “Previous feedback indicated that the wrapping step was difficult to understand; therefore, provide extra detail in that step.” By embedding such constraints, the server modifies the generative AI model's output distribution in a controlled manner.

The server communicates with the generative AI model through an application programming interface. The server constructs a request payload including the prompt sentence, a model identifier, and generation parameters such as temperature, maximum output length, and sampling configuration. The server sends the payload to a remote inference service that executes a neural language generation model. In one embodiment, the generative AI model comprises a transformer architecture with multiple self-attention layers, feed-forward layers, and positional encodings. The model has been trained using supervised learning and next-token prediction on large-scale text corpora, using an objective function such as cross-entropy loss and gradient-based optimization. During training, the model learned parameter weights that encode statistical associations among tokens and instructions, enabling the model to generate coherent packaging procedure information and packaging material information when conditioned on the prompt sentence.

The server receives the model output as textual data that includes a sequence of packaging steps, descriptions of required packaging materials, and optional explanatory notes. The server parses the textual data using rule-based parsing or lightweight natural language processing routines. The server identifies structural markers such as numbered lists, bullet points, and section headers, and converts the model output into structured packaging procedure information and packaging material information. The server thereby transforms a free-form text response into a normalized internal representation amenable to further algorithmic processing.

The server analyzes the packaging material information to create packaging material requirement information. The server maintains a mapping of synonyms and variant expressions for common packaging materials. The server applies a normalization procedure that converts different terms such as “bubble wrap,” “air cap,” or “cushioning film” into a canonical material type. The server extracts numerical parameters such as widths, lengths, thicknesses, and recommended quantities by scanning the text for measurement expressions and applying pattern matching. The server classifies materials into functional categories such as cushioning, container, sealing, or filler. The server stores the resulting packaging material requirement information as structured data that includes standardized material types, dimensional parameters, quantity ranges, and functional roles.

The server interfaces with an electronic transaction system to obtain recommended packaging material candidates. The server constructs search queries based on the packaging material requirement information, for example by combining normalized material types with dimension constraints and keywords for performance characteristics. The server sends the search queries as machine-readable messages via a network-based application programming interface provided by the electronic transaction system. The server receives transaction information including product identifiers, descriptive texts, prices, availability indicators, and references to product detail pages.

The server applies a selection algorithm to the transaction information. The server filters candidate products that do not satisfy numeric constraints such as minimum box dimensions or required width of cushioning material. The server can compute a suitability score for each candidate based on a weighted combination of factors such as price, match to dimensional requirements, rating scores, and shipping options. The server selects one or more top-ranked candidates for each material type and generates purchase reference information that includes, for each candidate, an identifier and a resource locator for the corresponding product page.

The server also generates packaging guide information that visually presents the packaging procedure. The server maintains a media library containing reusable visual information elements, such as still images, instruction diagrams, and short video segments that illustrate generic packaging operations, for example wrapping a fragile object, filling voids inside a container, or sealing a box. The server maps each step in the packaging procedure information to at least one visual information element using a step-to-media mapping table that associates step categories and material types with particular visual resources.

The server implements a video editing information processing unit using a media processing library. The server selects the appropriate visual information elements based on the mapping and concatenates relevant video segments into a unified video file. The server overlays text captions and annotations that correspond to the specific product attributes and selected packaging materials. The server generates timing information that aligns the captions with the video frames, and encodes the composed video into a distribution format with resolution and bit rate chosen to match typical capabilities of the terminal. The server may also generate static guide images by compositing product outline shapes, cushioning zones, and overlay text using the image processing information processing unit.

The terminal receives the packaging guide information and presents it on the display. The terminal executes a media player component or a browser-based video tag to stream the video from a content storage service. The terminal concurrently displays textual packaging procedure information and lists of recommended packaging material candidates. The user can follow the instructions and purchase the recommended materials by activating purchase reference links, which the terminal opens in a browser view connected to the electronic transaction system. The server thereby implements a specific technical data flow and internal data structures from acquisition of raw image data, through attribute extraction, structured prompt sentence construction, generative AI model invocation, output normalization, and media generation. The server does not merely automate a human mental process but transforms high-dimensional image data into compact attribute vectors, uses those vectors to condition a large-scale generative model in a reproducible manner, and converts unstructured text outputs into machine-checked material requirement data that can drive external system queries and media composition.

The server improves computational efficiency and accuracy in several ways. The server uses image resizing and normalization to reduce input dimensionality to the machine learning information processing unit, which decreases inference time and memory footprint. The server uses pre-defined mappings of attribute outputs to prompt sentence components, which constrains the prompts to a known format and reduces variability in generative AI responses. By doing so, the server increases the rate of successfully parsed model outputs and reduces the need for manual correction. The server normalizes packaging material information into structured requirement information, which decreases the number of redundant or unsuccessful search queries to electronic transaction systems, thereby reducing communication load and latency.

The server further improves accuracy and robustness by using feedback. The server acquires user evaluation information such as explicit satisfaction ratings or error reports and stores this information in association with corresponding attribute data, prompt sentences, and generative AI outputs. The server analyzes patterns in these evaluations and adjusts weightings in the prompt generation logic, for example by emphasizing damage risk when negative feedback frequently indicates breakage, or by requesting more conservative packaging instructions when fragile products are involved. This feedback-driven prompt adjustment is implemented as a deterministic modification of a finite set of templates and is executed by the server as a technical control flow, not as a mere business decision.

The server can employ multiple implementation variants. In one variant, the machine learning information processing unit runs on general-purpose central processing units. In another variant, the server uses graphics processing units or specialized accelerators to execute convolutional networks and transformer-based generative models, thereby further reducing processing time. In one variant, the server stores the neural network parameters locally, and in another variant, the server accesses a remote inference service for generative text but still implements all input conditioning, output parsing, and media generation locally. In a further variant, the server uses multiple different generative AI models for different languages or packaging domains and selects an appropriate model based on user condition information.

The server can also vary internal data structures. In one embodiment, the server represents product attributes, packaging procedures, and material requirement information in relational tables; in another embodiment, the server uses hierarchical document structures or graph-based representations that allow expressing dependencies between steps and materials. In each case, the controlled, structured representation enables deterministic processing sequences and facilitates caching and reuse, which reduces repeated calls to external services and improves overall throughput.

The terminal can be implemented as a smartphone, a tablet, a laptop, or another computing device with imaging and display capabilities. The server can also support multiple terminals for a single user, allowing the user to capture product images on one device and later view packaging guides on another device. The system thereby provides flexible, technically grounded packaging support across heterogeneous hardware environments while preserving the structured internal processing and the improvements in computation, data management, and communication efficiency.

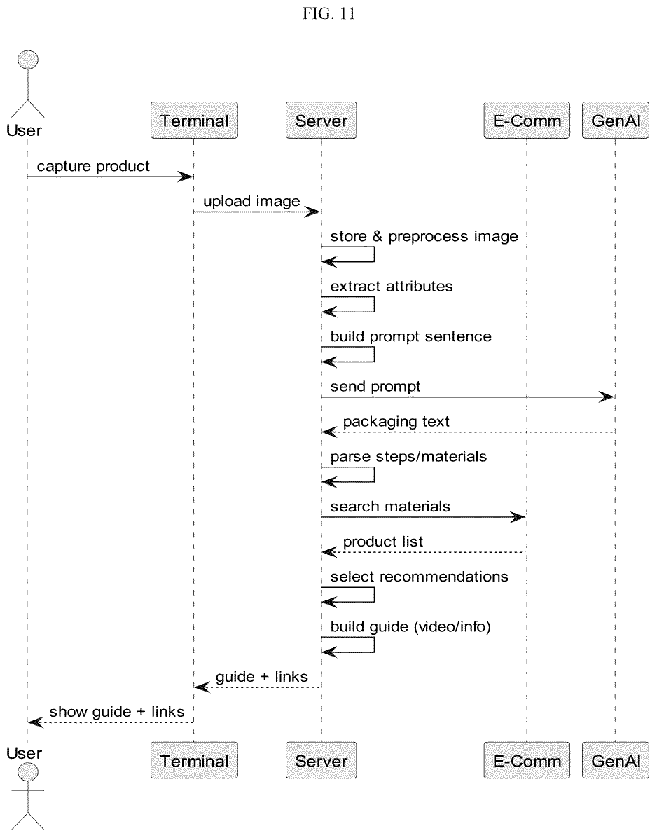

The following describes the processing flow using FIG. 11.

### Step 1:

The user operates the terminal to capture product image data.

The user launches an application or browser on the terminal, activates a camera interface, points the camera at the product, and presses a shutter control.

The terminal receives raw sensor signals from the camera hardware, executes image signal processing (including demosaicing, white balance, and noise reduction), and converts the signals into a digital image file in a format such as JPEG or PNG.

The input of Step 1 is an optical scene of the product, and the output of Step 1 is a digital image file stored in the terminal's temporary storage.

### Step 2:

The user operates the terminal to upload the product image data to the server.

The terminal displays a preview of the captured image, shows an upload control, and allows the user to confirm the image.

The terminal packages the image file and optional metadata (such as product name text, rough category, or notes) into an HTTP request body using multipart/form-data encoding and sends the request to the server via a communication network using a secure protocol.

The input of Step 2 is the digital image file and optional metadata stored on the terminal, and the output of Step 2 is a network message containing the image data transmitted to the server.

### Step 3:

The server receives and stores the product image data.

The server accepts the incoming HTTP request through a web server component, parses the headers and multipart body, and extracts the binary image data and metadata.

The server validates the image format, size, and basic integrity; if validation passes, the server writes the image data to a storage subsystem and creates or updates a database record that includes a storage path, a user identifier, and a session identifier.

The input of Step 3 is the network message containing the product image data from the terminal, and the output of Step 3 is a persistent image file and a corresponding database record stored on the server.

### Step 4:

The server preprocesses the stored image data for analysis.

The server reads the image file from storage into memory and uses an image processing library to decode the file into a pixel matrix in a standard color space.

The server resizes the matrix to a fixed resolution required by the machine learning model, normalizes pixel values to a specified numeric range, and optionally applies edge-enhancing or denoising filters to stabilize subsequent feature extraction.

The input of Step 4 is the stored image file and associated path information, and the output of Step 4 is a normalized numeric tensor representing the product image, suitable as input to a machine learning inference engine.

### Step 5:

The server extracts attribute information of the product using a machine learning information processing unit and additional image processing.

The server feeds the normalized image tensor into a convolutional neural network implemented in a machine learning framework and executes a forward pass to obtain feature vectors and output scores.

The server converts the model outputs into product attributes such as product category, shape type, dimension class, mass class, material class, and damage risk level by applying predefined mapping rules and threshold comparisons.

The server may refine the shape attribute by using an image processing library to perform contour detection, aspect-ratio calculation, and bounding-box analysis on the original or intermediate images.

The input of Step 5 is the normalized image tensor from Step 4, and the output of Step 5 is structured attribute information describing the product as a set of labeled fields and values.

### Step 6:

The server generates structured data representing the product attributes.

The server combines the individual attribute values into a single data structure such as a record or object that includes fields for product category, shape, dimension class, mass class, material class, and damage risk level.

The server attaches identifiers for the user and the session to this record and stores it in a database for later retrieval and correlation with other processing results.

The input of Step 6 is the attribute information produced in Step 5, and the output of Step 6 is a persistent structured data record that encodes the product's attribute information in a machine-readable format.

### Step 7:

The server constructs a prompt sentence for a generative AI model based on the structured attribute data.

The server loads a text template from configuration, inserts the attribute values into designated positions, and generates a natural-language instruction that specifies the context and required output format.

The server optionally incorporates user condition information, such as preferred cost level or shipping method, and user evaluation information, such as previous feedback, by appending or modifying clauses in the prompt.

The input of Step 7 is the structured data record containing product attributes and user-related information, and the output of Step 7 is a complete prompt sentence in textual form prepared for submission to a generative AI model.

### Step 8:

The server sends the prompt sentence to the generative AI model and obtains a response.

The server creates an application programming interface request that includes the prompt sentence, a selected generative model identifier, and configuration parameters such as temperature, maximum token count, and sampling strategy.

The server transmits this request over the network to a remote inference service running a generative AI model and waits for a response containing generated text.

The input of Step 8 is the prompt sentence and model configuration parameters, and the output of Step 8 is generated text data from the generative AI model that includes candidate packaging procedure information and packaging material information.

### Step 9:

The server parses and structures the generated packaging procedure information and packaging material information.

The server analyzes the generated text to detect sections, headings, numbered lists, and bullet lists, and then partitions the text into individual packaging steps and material descriptions. The server converts each identified step into a structured representation that includes at least a step index, an operation description, and references to required materials, and converts each material mention into a preliminary material item with descriptive fields. The input of Step 9 is the raw generated text from the generative AI model, and the output of

Step 9 is structured packaging procedure information and preliminary packaging material information stored in server memory or a database.

### Step 10:

The server normalizes and classifies packaging material information into packaging material requirement information.

The server applies a synonym dictionary and rule set to convert different textual labels for the same type of material into a canonical material type and resolves ambiguous expressions by preference rules.

The server extracts numeric values such as lengths, widths, thicknesses, and quantities using pattern matching on units and numbers, and assigns each material to a functional category such as cushioning, container, sealing, or filler.

The input of Step 10 is the preliminary packaging material information from Step 9, and the output of Step 10 is packaging material requirement information that includes standardized material types, dimensional parameters, quantity ranges, and functional categories.

### Step 11:

The server selects recommended packaging material candidates from an electronic transaction system.

The server constructs search queries based on the packaging material requirement information by embedding canonical material types and numeric constraints into query strings or API parameters.

The server sends the queries to an electronic transaction system via a network interface, receives product lists as transaction information, filters out products that do not satisfy dimensional or functional constraints, and ranks the remaining products according to criteria such as cost and availability.

The input of Step 11 is the packaging material requirement information, and the output of Step 11 is a set of recommended packaging material candidates, each associated with a product identifier and a purchase reference such as a resource locator.

### Step 12:

The server generates purchase reference information for the recommended packaging material candidates.

The server composes data records that include, for each candidate, product identifiers, brief descriptions, price information, and a reference link that allows the terminal to access a product detail page on the electronic transaction system.

The server associates these records with the current session and stores them in the database or prepares them for immediate transmission.

The input of Step 12 is the set of recommended packaging material candidates from Step 11, and the output of Step 12 is purchase reference information in a structured format suitable for display and interaction on the terminal.

### Step 13:

The server selects visual information elements corresponding to the packaging procedure steps.

The server consults a mapping table that associates categories of packaging operations and types of materials with specific visual elements stored in a media library, such as short instructional video clips or annotated images.

The server, for each step in the packaging procedure information, determines the operation type and the involved materials, and then chooses one or more matching visual information elements representing that operation and context.

The input of Step 13 is the structured packaging procedure information and the recommended packaging material candidates, and the output of Step 13 is a sequence of selected visual information elements aligned with the ordered procedure steps.

### Step 14:

The server generates packaging guide information by composing selected visual information elements.

The server uses a video editing information processing unit to concatenate selected video segments in the order of the packaging steps, overlay step numbers and short instructions as text captions, and, if necessary, apply transitions or timing adjustments to synchronize visuals and descriptions.

The server encodes the resulting sequence into a video file suitable for streaming or downloading and may also generate static composite images that highlight specific wrapping or filling configurations based on product attributes.

The input of Step 14 is the sequence of selected visual information elements from Step 13 and the textual packaging procedure information, and the output of Step 14 is packaging guide information including at least one encoded video file and optional accompanying images.

### Step 15:

The server transmits packaging guide information and purchase reference information to the terminal.

The server prepares a response payload that contains the packaging guide information, including media resource locations or embedded media descriptors, and the purchase reference information linking to the recommended packaging material candidates.

The server sends this payload to the terminal over the communication network, optionally using content delivery mechanisms optimized for media transmission, and records that the guide has been delivered for the session.

The input of Step 15 is the packaging guide information from Step 14 and the purchase reference information from Step 12, and the output of Step 15 is a network response containing these data items transmitted to the terminal.

### Step 16:

The terminal presents the packaging procedure and materials to the user.

The terminal receives the response payload from the server, decodes the structural data, and renders a user interface that shows the packaging steps as text, the recommended packaging materials with corresponding purchase controls, and a playback interface for the instructional video.

The terminal uses a media player component to stream or play back the video from a specified resource locator, while allowing the user to scroll through the text instructions and activate links that open product pages on the electronic transaction system.

The input of Step 16 is the response payload received from the server, and the output of Step 16 is the visual and interactive presentation of the packaging procedure information, the packaging guide information, and the purchase reference information on the terminal's display for use by the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional packaging support systems for commerce transactions mainly provide static manuals or rule-based recommendations that are not tailored to individual products or real-time user needs. In typical systems, a server may store fixed templates that map a coarse product category to a generic packaging guideline. Such an approach suffers from several technical drawbacks when deployed in a networked computing environment handling large-scale, heterogeneous product data.

First, when product information is limited to high-level category codes or manually entered text, a server cannot accurately infer detailed product characteristics such as material, size category, or damage risk level from actual product images. As a result, the server cannot generate precise packaging instructions, and must either over-protect or under-protect the product. Over-protection increases material consumption and shipping costs, while under-protection increases breakage rates. From a computing standpoint, this results in suboptimal use of processing resources, because the server repeatedly executes the same coarse rule sets, regardless of finer-grained image-based characteristics.

Second, existing systems do not integrate image analysis processing, generative models, and commerce transaction processing into a coherent, machine-executable flow. Image analysis services and generative models are often used in isolation. A conventional server may call an image recognition service to label an image, or may call a generative model based on manually crafted prompts, but does not automatically transform structured image-derived characteristics into optimized prompt sentences, and does not loop the resulting generated content back into a commerce workflow. Consequently, the server cannot automatically select concrete packaging material items from an electronic transaction system based on generated packaging plans, and must rely on manual mapping or static SKU lists. This leads to increased latency, higher error rates in SKU selection, and a lack of scalability when new materials or products are added.

Third, generative models in conventional systems are typically used in a one-shot manner without systematic feedback integration. That is, generated packaging instructions are presented to users, but the server does not capture usage status information or user evaluation information as machine-readable feedback and does not adjust prompt sentences or model interaction parameters accordingly. From a computer-technical perspective, this means that the system does not improve its generation behavior over time and does not adapt to real-world failure patterns or user preferences. The result is that computing resources are expended repeatedly to generate suboptimal guidance, and the system cannot evolve its prompt engineering strategy in a data-driven manner.

Fourth, there is a lack of structured communication between the product characteristic extraction stage and the generative model stage. Conventional prompts are often free-form and omit structured fields such as size category, damage risk level, and delivery condition information. This causes ambiguity in the generative model input, leading to unstable or inconsistent generation results. At the system level, this ambiguity introduces unnecessary variability, which can require additional manual review or post-processing logic, thereby increasing processing complexity and reducing throughput.

Accordingly, there is a need for a computer-implemented system that:
(1) automatically acquires product characteristic information from product image data using an image analysis processing apparatus,
(2) converts the product characteristic information and delivery condition information into structured prompt sentences suitable for interaction with a generative information processing model,
(3) uses the generative information processing model to generate a packaging procedure and packaging material configuration,
(4) automatically maps the generated packaging material configuration to concrete merchandise identification information in a material sales electronic transaction system and generates purchase screen information including special price information, and
(5) generates and delivers packaging guide information in the form of visual and/or audio content to user terminals, while collecting feedback information for iterative refinement of prompt sentences and generative behavior.

By addressing these issues, the invention aims to improve the functioning of a server-based computer system, specifically by reducing manual configuration of prompts, lowering SKU selection errors, decreasing network and processing overhead associated with repeated rule-based execution, and increasing the stability and accuracy of generated packaging guidance in response to diverse product images and user behavior.

The specific processing by the specific processing unit 290 of the data processing device 12 in Application Example 1 is realized by the following means.

The present invention provides a server comprising a processor configured to acquire product image data, to transmit the product image data to an image analysis processing apparatus, and to specify product characteristic information, including at least a product type, a material, a size category, and a damage risk level, based on an analysis result obtained from the image analysis processing apparatus; to generate, based on the product characteristic information and delivery condition information, a prompt sentence for instructing a generative information processing model to propose an optimal packaging procedure and a required packaging material configuration, and to input the generated prompt sentence into the generative information processing model to obtain response information including the packaging procedure and the packaging material configuration from the generative information processing model; to extract packaging material types and quantity information from the response information, to associate the packaging material types with merchandise identification information in a material sales electronic transaction system, and to select a recommended packaging material set; to acquire transaction information of the material sales electronic transaction system for the recommended packaging material set, to generate purchase screen information including special price information, and to provide the purchase screen information to a user terminal so as to enable execution of a purchase process for packaging materials via the material sales electronic transaction system based on a purchase instruction from the user terminal; to generate packaging guide information including visual content and/or audio content indicating work contents and used materials for respective steps, based on the packaging procedure obtained from the generative information processing model and packaging material information for which the purchase process has been completed; to transmit the packaging guide information to the user terminal so that the packaging guide information is displayed or played back on the user terminal; and to control the generative information processing model to receive usage status information of the packaging guide information and evaluation information acquired from a user as feedback information, and to adjust contents or constituent elements of the prompt sentence so as to improve an accuracy of proposals of the packaging procedure and the packaging material configuration to be generated thereafter. This enables a technical improvement of a computer-implemented packaging support system, in which the server automatically transforms image-derived product characteristics into structured prompt sentences, orchestrates interactions with a generative information processing model and an electronic transaction system, and iteratively refines generation behavior based on machine-readable feedback, thereby reducing manual intervention, improving resource utilization, and enhancing the precision and stability of packaging guidance delivered to user terminals.

The term “product image data” refers to digital image information representing an item to be packaged, the information including at least pixel values and a file format suitable for processing by an image analysis processing apparatus and transmission by a server.

The term “image analysis processing apparatus” refers to a computing resource, implemented by hardware and software, that receives product image data and executes image analysis algorithms to output structured analysis results, such as detected object types, shapes, and visual attributes.

The term “analysis result” refers to structured data generated by the image analysis processing apparatus from product image data, the structured data including one or more labels, feature values, or confidence scores indicating visual characteristics of the item.

The term “product characteristic information” refers to information specifying one or more attributes of an item based on the analysis result, the attributes including at least a product type, a material, a size category, and a damage risk level.

The term “product type” refers to a classification of an item into a category indicative of its general form or use, such as a container, a decorative object, or an electronic apparatus, determined based on the analysis result and optionally additional data.

The term “material” refers to a kind of substance forming the main body of the item, such as a brittle substance, a polymer substance, a metallic substance, or a fibrous substance, inferred from the analysis result and used for packaging decision making.

The term “size category” refers to a discrete classification of the physical size of the item, such as small, medium, or large, or equivalent ranges, determined from the analysis result and optionally supplementary information.

The term “damage risk level” refers to an indication of an expected susceptibility of the item to breakage or damage during handling or transport, classified into one or more levels based on the analysis result and predefined rules.

The term “delivery condition information” refers to information indicating one or more constraints or contexts for transportation of the item, such as shipping method, transit distance, carrier requirement, or environmental condition, which is used together with product characteristic information to determine packaging requirements.

The term “prompt sentence” refers to machine-processable text or a structured expression used as input to a generative information processing model, the text or expression encoding product characteristic information and delivery condition information so as to instruct the model to generate a packaging procedure and a packaging material configuration.

The term “generative information processing model” refers to a trained computational model that receives a prompt sentence and generates, as output, textual or structured information, including at least a packaging procedure and a packaging material configuration, by performing probabilistic or learned transformations of the input.

The term “packaging procedure” refers to a sequence of one or more steps describing operations for enclosing and protecting the item using packaging materials, the operations including at least wrapping, cushioning, placing in a container, and sealing.

The term “packaging material configuration” refers to a set of one or more packaging material types and associated parameters, such as quantity, size, or thickness, suitable for implementing the packaging procedure for the item.

The term “response information” refers to information output by the generative information processing model in response to a prompt sentence, the information including at least the packaging procedure and the packaging material configuration in textual or structured form.

The term “packaging material type” refers to a classification of a packaging resource, such as a cushioning medium, a container, or a fastening medium, identified as suitable for use in the packaging procedure.

The term “quantity information” refers to data indicating an amount or count of each packaging material type required for performing the packaging procedure, such as a number of units, a length, a volume, or a weight.

The term “material sales electronic transaction system” refers to an information processing system that manages product listings, pricing, stock, and ordering for packaging materials, and that provides an interface for electronic purchase transactions.

The term “merchandise identification information” refers to data identifying a commercial article in the material sales electronic transaction system, such as a product code, an item identifier, or a stock keeping unit.

The term “recommended packaging material set” refers to a selection of one or more packaging material types, each associated with merchandise identification information and quantity information, determined as suitable for implementing the packaging procedure for the item.

The term “transaction information” refers to data obtained from the material sales electronic transaction system regarding the recommended packaging material set, the data including at least price information, availability information, and optionally discount information.

The term “purchase screen information” refers to data for presentation on a user terminal that describes the recommended packaging material set, including at least item details, prices, and user interface elements to receive a purchase instruction.

The term “special price information” refers to data indicating a preferential price lower than a reference price, applied to at least one packaging material in the recommended packaging material set under specified conditions.

The term “user terminal” refers to an information processing device operated by an end user, such as a computing device or a communication device, configured to communicate with the server, display information, and send user instructions including purchase instructions.

The term “purchase instruction” refers to a signal or data generated by user interaction with the user terminal and transmitted to the server, the signal or data indicating user approval to acquire one or more packaging materials under specified conditions.

The term “purchase process” refers to a sequence of operations executed by the server and the material sales electronic transaction system to complete an electronic transaction for packaging materials, including order creation, payment processing, and confirmation.

The term “packaging material information” refers to data describing packaging materials for which the purchase process has been completed, the data including at least identification, quantity, and, optionally, expected delivery information.

The term “packaging guide information” refers to information generated by the processor to instruct a user in performing the packaging procedure using the purchased packaging materials, the information including at least visual content and/or audio content indicating work contents and used materials for respective steps.

The term “visual content” refers to image data or video data, including still images, moving images, or graphical representations, that depict or illustrate operations or configurations in the packaging procedure.

The term “audio content” refers to sound data, including recorded speech, synthesized speech, or audio cues, that provide instructions or guidance relating to the packaging procedure.

The term “usage status information” refers to data indicating how the packaging guide information has been accessed or used on the user terminal, such as viewing duration, completion of steps, or interaction events, collected for feedback purposes.

The term “evaluation information” refers to data representing a user assessment of the packaging guide information or packaging result, such as a rating, a comment, or a selection from predefined options, transmitted from the user terminal to the server.

The term “feedback information” refers to a combination of usage status information and evaluation information, or either of them, used by the processor to adjust contents or constituent elements of the prompt sentence or to modify interaction with the generative information processing model.

The term “contents or constituent elements of the prompt sentence” refers to individual parts of the prompt sentence, such as fields, phrases, or structured segments, that encode product characteristic information, delivery condition information, or instruction constraints supplied to the generative information processing model.

The term “accuracy of proposals” refers to the degree to which the packaging procedure and the packaging material configuration proposed by the generative information processing model are appropriate for protecting the item under given delivery conditions, measured according to one or more criteria such as damage rate, material efficiency, or user satisfaction.

In one or more embodiments, a server, a terminal, and a user cooperate to implement the present invention. The server executes a computer program on one or more processors and memories, the terminal executes a client-side application, and the user operates the terminal and performs physical packaging operations in the real world.

### A. Overall System Configuration

The server uses general-purpose computing hardware, such as a rack-mounted server including a multi-core central processing unit (CPU), main memory (DRAM), non-volatile storage (SSD), and a network interface card connected to a packet-switched network. In some embodiments, the server additionally uses a graphics processing unit (GPU) for accelerating neural network inference.

The terminal uses a portable information processing device, such as a smartphone or tablet computer, including a camera module, a touch-sensitive display, a mobile application processor, local storage, and wireless communication modules. The terminal executes a native application (for example, an application developed using mobile application frameworks such as Swift/Objective-C for a specific mobile operating system or Kotlin/Java for another mobile operating system), or a cross-platform application framework (for example, a reactive user interface framework).

The server and the terminal communicate via a network using a transport protocol such as HTTPS over TCP/IP. The server exposes application programming interfaces (APIs) through a web server and an application framework (for example, a combination of a HTTP server and a web application framework), and the terminal accesses these APIs to upload product image data, retrieve packaging proposals, and obtain packaging guide information.

The server also communicates with an image analysis processing apparatus and a material sales electronic transaction system. In one embodiment, the image analysis processing apparatus is implemented as a cloud-based image recognition service providing an API for label detection and object localization. The material sales electronic transaction system is implemented as an e-commerce backend including product catalogs, pricing databases, order management modules, and payment gateways.

### B. Hardware and Software Components on the Server

The server uses the following functional modules implemented as software components:
(1) An image reception module that receives product image data from the terminal over the network, verifies file types and sizes, and stores the images in a storage system such as a distributed object storage.
(2) An image analysis interface module that formats requests to the image analysis processing apparatus, sends image data or image references, and receives and parses structured analysis results.
(3) A product characteristic extraction module that transforms raw analysis results into product characteristic information. This module implements rules and statistical mappings, for example, mapping combinations of labels and bounding box geometries to normalized product type and size category codes.
(4) A prompt construction module that assembles a prompt sentence for a generative AI model. This module uses a predetermined schema to embed product type, material, size category, damage risk level, and delivery condition information into structured natural language.
(5) A generative model interface module that transmits the prompt sentence to an external generative AI model or an internal generative AI model implemented by the server, receives textual output, and converts the textual output into structured representations of a packaging procedure and a packaging material configuration.
(6) A material mapping module that associates packaging material types from the packaging material configuration with merchandise identification information in the material sales electronic transaction system, taking into account availability, stock, and pricing.
(7) A purchase screen generation module that composes purchase screen information including detailed material descriptions, itemized and total prices, and special price information, and sends this information to the terminal.
(8) A packaging guide generation module that converts the packaging procedure and purchased packaging material information into packaging guide information, including visual content and/or audio content. In one embodiment, this module uses script templates and multimedia generation tools to create step-by-step instructional videos and images.
(9) A feedback collection module that receives usage status information and evaluation information from the terminal, stores this feedback, and passes aggregated feedback to a prompt adjustment module.
(10) A prompt adjustment module that modifies the contents or constituent elements of the prompt sentence based on feedback, for example, by adjusting weightings of specific fields, changing phrasing patterns, or altering the level of detail requested from the generative AI model.

### C. Generative AI Model Structure and Operation

The server uses a generative AI model implemented as a neural network-based language model. In one embodiment, the generative AI model is a transformer-based architecture including an embedding layer, multiple self-attention layers, feed-forward layers, and an output projection layer. The generative AI model is trained on large-scale text data, including technical manuals, logistics documents, and packaging-related descriptions.

The generative AI model receives a tokenized prompt sentence as input. The prompt sentence is encoded into a sequence of token embeddings, and the transformer layers repeatedly apply multi-head self-attention and position-wise feed-forward operations. The model computes probability distributions over a vocabulary for each output position and samples or selects tokens according to these distributions.

In training, the generative AI model uses a loss function such as cross-entropy between predicted token distributions and ground-truth tokens in the training corpus. Gradients of the loss function are computed via backpropagation and used to update model weights with an optimizer such as stochastic gradient descent with adaptive learning rates. In fine-tuning for packaging tasks, the model is trained on domain-specific pairs of prompt sentences and reference packaging procedures and packaging material configurations.

By defining a prompt structure that includes explicit markers for product type, material, size category, damage risk level, and delivery conditions, the generative AI model receives more constrained and informative input. This reduces ambiguity in the generative process and improves convergence of the output distribution toward appropriate packaging solutions. As a technical effect, the server reduces the number of tokens needed to achieve a given quality level of output, thus decreasing compute time and network bandwidth for API calls.

### D. Data Structures and Internal Representations

The server represents product characteristic information as a structured record, for example:
a product type field encoded as a category code,
a material field encoded as a material code,
a size category field encoded as a size class code,
a damage risk level field encoded as a discrete level,
a delivery condition field indicating transport constraints.

The prompt construction module maps these fields into a natural language format with labeled sections, such as:

“This product is of type [TYPE_CODE], made of [MATERIAL_CODE], belonging to size category [SIZE_CODE], with damage risk level [RISK_LEVEL]. The delivery conditions are [CONDITIONS]. Please propose the optimal packaging method and necessary packaging materials.”

By consistently structuring the prompt sentence, the server imposes an internal protocol between the product characteristic extraction module and the generative model interface module. This protocol constitutes a non-conventional data flow that improves machine interpretation and reproducibility.

The packaging procedure is represented internally as an ordered list of steps, each step including a step index, a textual instruction, and references to packaging material types and quantities used in that step. The packaging material configuration is represented as a list of material entries, each including a material type code, recommended dimensions, and quantity information. The material mapping module associates material type codes with merchandise identification information in the material sales electronic transaction system by applying mapping rules and relevance scores. For example, the module may compute a similarity score between a material type descriptor and product titles in the catalog, and then select the highest-scoring merchandise identifiers satisfying dimensional and stock constraints.

### E. Example of Prompt Sentences

In one specific example, the server constructs the following prompt sentence:

“This product is a fragile ceramic flower vase, about 30 cm tall and 12 cm in diameter. The customer will return it via standard parcel delivery. Please propose the optimal packing method and necessary packing materials. Describe the method step by step and specify approximate box size and amount of cushioning.”

In another example, when generating a script for a packaging guide, the server uses:

“Based on the following packing method, create a script for a short tutorial video. Divide the process into clear steps, each with a short caption suitable for on-screen text. Make the instructions easy to understand for a non-expert user.”

These prompt sentences are not arbitrary descriptions but are systematically constructed using the prompt construction module, which selects specific phrases and ordering to achieve stable, high-quality outputs from the generative AI model.

### F. Technical Effects and Improvements in Computer Technology

The server improves computer technology in several ways.

First, the server reduces computational waste by transforming raw image analysis results into compact, normalized product characteristic information before constructing prompt sentences.

Without this step, a generative AI model would have to process unstructured image labels and possibly redundant descriptive text, increasing sequence length and inference time. By compressing information into structured fields and standardized phrases, the server shortens prompts and reduces inference latency, leading to faster response times and lower compute resource usage.

Second, the server improves accuracy of packaging recommendations by combining image-derived characteristics and delivery conditions in a structured manner. Conventional rule-based systems apply static rules that fail to adapt to subtle differences in size or material. The server instead uses a neural network trained on a rich corpus, and supplies to it fine-grained product characteristic information, leading to lower error rates in packaging recommendations and reduced breakage rates. This constitutes a technical improvement in the functioning of the computer system that computes and delivers packaging instructions.

Third, the server implements a feedback loop at the level of prompt construction and model interaction. The feedback collection module aggregates usage status and evaluation information from multiple terminals and stores statistics such as which prompt patterns yield high user satisfaction and low damage incidents. The prompt adjustment module alters the prompt templates by adjusting weights or including additional fields (for example, repeated emphasis on fragility for certain categories). This closed-loop optimization is not a mere automation of human judgment; it configures the machine to modify its own input representation to the generative AI model based on measured performance, thereby improving the behavior of the computer system over time in a manner that humans cannot feasibly perform at scale.

Fourth, the server reduces communication load between modules by using compact, task-specific data structures. For example, the server passes product characteristic information as numeric codes and delivery conditions as concise tags rather than long text descriptions. The generative AI model interface module only needs to assemble a compact prompt sentence containing these codes expanded into concise words, which reduces the size of network payloads between the server and any external model hosting infrastructure. This technical measure lowers network latency and bandwidth consumption.

Fifth, the server integrates image analysis, generative modeling, and electronic transaction processing into a unified control flow that operates with minimal manual intervention. The material mapping module programmatically associates packaging material types from the generated configuration to concrete merchandise identifiers, using similarity scoring and rules. This is not equivalent to a human operator manually selecting items from a catalog; instead, the server applies deterministic and probabilistic algorithms to map abstract material types to specific products, and this mapping process directly affects subsequent purchase processing. The result is a reduction in human error and a consistent, scalable process that improves the reliability of the underlying computing infrastructure.

### G. Variations of the Generative AI Model and Learning Methods

In one embodiment, the server uses an external generative AI model provided as a managed service. In another embodiment, the server hosts an internal generative AI model. The internal model may be a transformer-based language model with a specified number of layers, attention heads, and hidden units. The server trains the model using a curated dataset of historical packaging instructions and outcomes.

The server may apply supervised fine-tuning where each training sample consists of a prompt sentence and an ideal packaging procedure and packaging material configuration. The loss function is computed as the sum of cross-entropy losses over target tokens. The server may also use reinforcement learning methods, where the reward is based on downstream metrics such as damage rates or user ratings, and perform policy gradient updates to encourage generation patterns that minimize damage or maximize user satisfaction.

The server may employ data augmentation methods to improve robustness, such as paraphrasing product descriptions, varying numeric dimensions within ranges, or randomly masking minor fields in the prompt. These methods allow the model to generalize better to unseen products while maintaining structured reliance on product characteristic information.

### H. Detailed Behavior on the Terminal and Interaction With Physical Packaging

The terminal captures product image data using camera control APIs and transmits it to the server. The terminal receives purchase screen information and displays recommended packaging material sets, including special price information, in an interactive user interface. When the user completes a purchase, the terminal receives confirmation and later receives packaging guide information including visual content and/or audio content.

The user uses the terminal to view the step-by-step packaging guide. The guide shows concrete physical operations, such as “wrap the product in three layers of cushioning material,” “place the product in the inner container,” “fill gaps with void-fill material,” and “insert the inner container into the outer container.” The user then physically executes these operations with the real packaging materials. The terminal can record which steps the user views or marks as completed, and transmits this usage status information to the server.

The system thus directly influences the physical state of products and packaging materials in the real world. The server-generated guides determine how the user wraps, cushions, and boxes the product. This is not a purely abstract data manipulation; it is a computer-controlled improvement in how physical packaging is performed, leading to reduced damage during shipping and more efficient use of materials.

### I. Alternative Embodiments and Configurations

In one embodiment, the server uses a different type of image analysis processing apparatus, such as a convolutional neural network for object detection running locally on the server hardware. In this case, the server receives product image data, processes it with the local neural network, and directly obtains bounding box coordinates and class predictions. The product characteristic extraction module uses these results to determine material and size category.

In another embodiment, the server uses a rules-enhanced generative AI model. The model output is post-processed by a rule engine that enforces constraints such as maximum box weight or minimum cushioning thickness. This rule engine may encode domain-specific constraints and safety margins, and the combination of learned generative behavior and deterministic rule application provides higher reliability than either alone.

In a further embodiment, the packaging guide generation module does not generate video but instead generates a sequence of annotated images. The server uses a graphics library to render schematic diagrams and overlay markers indicating where to place cushioning and how to position the product. The visual content is optimized for low bandwidth, making it suitable for terminals with limited network speed.

In another embodiment, the feedback collection module aggregates usage status information from a large population of users and clusters guides into successful and unsuccessful groups based on breakage reports. The prompt adjustment module then updates prompt templates to emphasize specific constraints, such as reinforcing corners for certain product types, thereby improving overall system performance through data-driven reconfiguration.

Through these embodiments, the server, the terminal, and the user cooperate in a technically specific manner. The server executes non-conventional sequences of data transformations and model interactions, the terminal captures and displays information using dedicated hardware and software interfaces, and the user performs real-world packaging according to machine-generated guides. The result is an improvement in computer-based packaging support that goes beyond mere automation of human judgment and achieves better speed, accuracy, and resource efficiency.

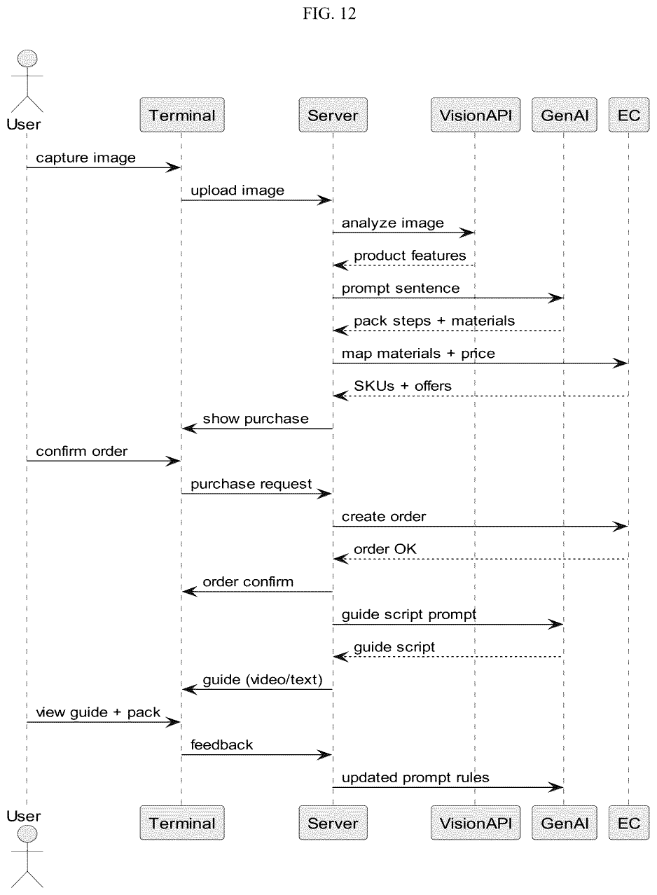

The following describes the processing flow using FIG. 12.

### Step 1:

The user operates the terminal to capture at least one image of a product, using a camera application interface provided by a client application.

The terminal receives raw sensor data from the camera hardware as input and converts the raw sensor data into product image data in a compressed format, such as JPEG, by executing image encoding functions of an operating system framework.

The terminal performs optional preprocessing, including resizing the image to a predetermined maximum resolution and removing location metadata, by executing image processing operations on the pixel data.

The terminal outputs the preprocessed product image data and temporarily stores it in local storage together with a locally generated image identifier.

### Step 2:

The terminal prepares a transmission request including the product image data and user identification information.

The terminal uses the product image data as input, encapsulates the image data into a multipart/form-data HTTP request, adds headers containing authentication tokens, and computes a content length value.

The terminal transmits the request to the server over a secure communication channel and outputs the request to a network interface module.

### Step 3:

The server receives the request from the terminal and extracts the product image data and user identification information.

The server uses the request payload as input, verifies authentication tokens by comparing them with stored credential records, checks a MIME type and file size of the image, and rejects data that do not satisfy predetermined criteria.

The server outputs validated product image data and generates a unique image identifier, then stores the image data in a storage system and records metadata including the image identifier and user identifier in a database.

### Step 4:

The server transmits the product image data or a reference to the stored image to an image analysis processing apparatus.

The server uses the stored image data or its storage location as input, constructs a request message conforming to an image analysis API, specifying operations such as label detection and object localization, and sends the message to the image analysis processing apparatus.

The server receives an analysis result as output, the analysis result including labels, bounding boxes, and confidence scores in a structured data format.

### Step 5:

The server derives product characteristic information from the analysis result.

The server uses the analysis result as input, applies rule-based mappings and numerical calculations, including mapping label combinations to a product type, estimating a size category from bounding box dimensions, inferring a material from characteristic labels, and assigning a damage risk level based on a lookup table.

The server outputs product characteristic information including at least a product type, a material, a size category, and a damage risk level, and stores this information in the database associated with the image identifier.

### Step 6:

The server obtains delivery condition information related to the product.

The server uses user profile data, order context, or explicit user input as input, determines delivery conditions including shipping method and distance, and normalizes these conditions into predefined delivery condition codes.

The server outputs delivery condition information and associates it with the corresponding product characteristic information.

### Step 7:

The server constructs a prompt sentence for a generative AI model based on the product characteristic information and the delivery condition information.

The server uses the product type, material, size category, damage risk level, and delivery condition codes as input, selects phrase templates from a prompt template repository, replaces placeholders with corresponding values, and concatenates multiple sentence fragments in a fixed order to form a grammatically correct prompt.

The server outputs a prompt sentence such as:

“This product is a fragile ceramic flower vase, about 30 cm tall and 12 cm in diameter. The customer will return it via standard parcel delivery. Please propose the optimal packing method and necessary packing materials. Describe the method step by step and specify approximate box size and amount of cushioning.”

### Step 8:

The server sends the prompt sentence to a generative AI model and obtains a packaging procedure and a packaging material configuration.

The server uses the prompt sentence as input, tokenizes the text into a sequence of tokens according to a predefined vocabulary, and sends the token sequence to a transformer-based generative AI model.

The generative AI model computes, for each output position, a probability distribution over tokens by executing multiple layers of self-attention and feed-forward operations on vector representations of the tokens.

The server receives an output token sequence, decodes the sequence back into text, and outputs response information including a textual description of a step-by-step packaging procedure and a list of required packaging materials with quantities and approximate dimensions.

### Step 9:

The server converts the response information into structured representations of the packaging procedure and the packaging material configuration.

The server uses the generated text as input, applies parsing rules such as detecting numbered steps and bullet lists, and identifies phrases describing material types, quantities, and sizes.

The server separates the text into an ordered list of packaging steps and a list of packaging material entries, each entry including at least a material name, a recommended dimension, and a quantity.

The server outputs structured packaging procedure data and a structured packaging material configuration and stores them in the database.

### Step 10:

The server maps packaging material types in the packaging material configuration to merchandise identification information in a material sales electronic transaction system.

The server uses the structured packaging material configuration as input, for each material entry constructs a query including keywords and dimension constraints, and sends the query to a catalog search interface of the electronic transaction system.

The server receives candidate merchandise records including product titles, descriptions, prices, and stock levels, computes similarity scores between material descriptors and merchandise descriptors, filters out records that violate dimensional or stock constraints, and selects the merchandise identifier with the highest score for each material type.

The server outputs a recommended packaging material set including associated merchandise identification information and updated quantity information.

### Step 11:

The server acquires transaction information and generates purchase screen information including special price information.

The server uses the recommended packaging material set as input, requests current prices, discount eligibility, and availability from the material sales electronic transaction system, and calculates total prices for different combinations including discounts.

The server generates a purchase screen data structure including item names, unit prices, discounted prices, total cost, images, and selectable quantity fields.

The server outputs the purchase screen information and transmits it to the terminal.

### Step

12:

The terminal displays the purchase screen information and receives a purchase instruction from the user.

The terminal uses the purchase screen information as input, renders a user interface listing recommended packaging materials, special prices, and total cost, and enables interactive controls for modifying quantities and confirming a purchase.

The user reviews the information, adjusts quantities if desired, and operates a purchase confirmation control.

The terminal captures the selected items and quantities as input, forms a purchase instruction message including user identification and payment preference information, and outputs this message to the server over the network.

### Step 13:

The server executes a purchase process for the packaging materials via the material sales electronic transaction system.

The server uses the purchase instruction, selected merchandise identification information, and quantity information as input, calls an order creation API of the electronic transaction system, and passes item identifiers, quantities, and applied discounts.

The server receives an order confirmation or error status as output, and in case of confirmation, records order details including order identifier and expected delivery date in the database.

The server outputs purchase completion information and transmits it to the terminal.

### Step 14:

The terminal notifies the user of the purchase completion.

The terminal uses the purchase completion information as input, displays an order confirmation screen showing order identifier, purchased items, prices, and estimated delivery date.

The terminal outputs completion feedback to the user and stores a reference to the order for later access.

### Step 15:

The server generates packaging guide information based on the packaging procedure and purchased packaging material information.

The server uses the stored packaging procedure, the purchased packaging material configuration, and optional constraints such as maximum guide length as input, and constructs a detailed guide script including step titles, textual descriptions, and references to specific materials for each step.

The server then uses multimedia generation tools to convert the script into visual content and/or audio content, for example by generating a sequence of slides with text overlays and images, or by synthesizing speech from text instructions.

The server outputs packaging guide information including at least one video file and/or a set of annotated images plus text descriptions, and stores the guide information in association with the product and order records.

### Step 16:

The server transmits the packaging guide information to the terminal.

The server uses the guide metadata, such as file locations and formats, as input, creates an access description for the terminal including URLs or identifiers, and sends a guide notification message to the terminal.

The server outputs the guide information or references thereto in a response message, enabling the terminal to retrieve and present the guide.

### Step 17:

The terminal receives and presents the packaging guide information to the user.

The terminal uses the guide information or references as input, retrieves actual media files if necessary, and invokes local playback components to display images and play video and/or audio.

The terminal presents step-by-step instructions on the display, including captions and indicators of required materials for each step, and may provide interactive controls for moving between steps or marking steps as completed.

The terminal outputs visual and/or audio signals to the user and captures usage status information, such as timestamps of step views and completion flags.

### Step 18:

The user performs physical packaging operations using the purchased packaging materials while referring to the packaging guide information.

The user uses the visual and/or audio instructions as input, manipulates physical packaging materials, such as cushioning media and containers, and executes wrapping, placing, and sealing operations as indicated in the steps.

The user completes the packaging of the product and may operate controls on the terminal to indicate completion or to submit an evaluation.

The user outputs evaluation information, such as a rating or comment, to the terminal.

### Step 19:

The terminal transmits usage status information and evaluation information to the server.

The terminal uses user interactions and guide playback logs as input, aggregates viewing durations, step completion states, and explicit ratings into structured feedback data, and sends this feedback data to the server via an API call.

The terminal outputs the feedback data to the server for further processing.

### Step 20:

The server adjusts prompt sentence construction based on the feedback information.

The server uses the usage status information and evaluation information as input, analyzes correlations between prompt patterns, product categories, and user satisfaction or damage incidents, and computes adjustment parameters such as weights for including additional detail about certain product characteristics.

The server modifies prompt templates or field ordering rules, for example by adding explicit emphasis on damage risk level for fragile items or by requesting more granular box dimension recommendations.

The server outputs updated prompt construction rules, which will be applied in future executions of the prompt construction module, thereby improving the accuracy and consistency of packaging procedures and packaging material configurations generated by the generative AI model.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for selecting packaging materials and packaging methods for shipping articles rely heavily on manual configuration, static rule sets, and ad hoc interaction with commerce platforms. In many such systems, a server simply receives basic product information and forwards it to a fixed recommendation engine or a static database lookup. These approaches suffer from several technical problems.

First, existing systems typically do not dynamically transform structured product attributes into optimized natural language prompt sentences suitable for a generative AI model. As a result, the interaction between the server and the generative AI model is inefficient and suboptimal: crucial product attributes (such as dimensions, mass, shape, and destination) may be omitted, inconsistently expressed, or redundantly provided. This can lead to increased inference errors, unstable model outputs, and a need for repeated queries, thereby consuming unnecessary network bandwidth and processing resources.

Second, conventional architectures generally treat the generative AI model's output as unstructured free text and do not tightly integrate that output into downstream data processing pipelines. In particular, there is often no robust server-side mechanism for converting generative AI outputs into structured packaging material specifications, mapping those specifications into query parameters for external commerce application programming interfaces, and composing coherent packaging material sets. This lack of integration forces additional manual processing or client-side logic, causing fragmented data flows, increased latency, and inconsistent recommendation quality.

Third, typical systems do not incorporate a closed feedback loop in which user evaluation or feedback directly influences the construction of prompt sentences and the conditions for interacting with the generative AI model. Without such a feedback-driven adjustment mechanism at the server level, the system cannot systematically learn from user behavior to refine prompt generation strategies, reduce unnecessary queries, or improve prediction accuracy over time. This leads to repeated ineffective prompts, wasted computational cycles, and degraded user experience.

Thus, there is a need for an improved computer-implemented system and method that: (i) systematically converts structured product attribute data into optimized natural language prompt sentences for a generative AI model; (ii) programmatically converts the generative AI model's responses into structured packaging material candidate data and into search parameters for external commerce platforms; and (iii) employs user feedback to adapt the prompt generation and model interaction logic. Such a system should improve the efficiency, reliability, and scalability of packaging recommendation and purchase flows from the perspective of computer technology and networked information processing.

The specific processing by the specific processing unit 290 of the data processing device 12 in Example 2 is realized by the following means.

The present invention provides a server comprising a processor configured to receive, from a user terminal via a communication network, structured product-related information including at least dimensional information, mass information, shape information, and destination information regarding an article to be packaged; to generate, on the basis of product attribute information including the structured product-related information, a prompt sentence that expresses the product attribute information in a natural language form and instructs a generative AI model to propose an optimal packaging method; to input the prompt sentence into the generative AI model and obtain response information relating to the proposed packaging method; to convert the response information into structured data specifying at least one type and quantity of packaging material; to generate packaging material candidate information from the structured data; to acquire, on the basis of the packaging material candidate information, product information relating to packaging materials from an external commercial transaction information processing apparatus by using an external application programming interface; to combine a plurality of packaging materials included in the product information to constitute at least one packaging material set and generate recommended packaging material set information for each packaging material set; to generate work instruction information, based on the response information and the recommended packaging material set information, for executing the proposed packaging method using purchased packaging materials; and to transmit the recommended packaging material set information and the work instruction information to the user terminal for display. This enables an integrated computer-implemented workflow in which the server efficiently transforms structured product data into optimized natural language prompt sentences, orchestrates interaction with a generative AI model, programmatically converts model outputs into structured queries to an external commerce platform, composes coherent packaging material sets, and adaptively improves prompt generation and model interaction based on feedback, thereby reducing processing overhead, improving response stability, and enhancing the technical performance of packaging recommendation and purchasing operations in a networked computing environment.

The term “processor” refers to a hardware or virtual computing element, such as a central processing unit or a processing core within a computing apparatus, that executes program instructions to perform arithmetic operations, logical operations, data transfers, and control flows required to implement one or more functions of the system.

The term “product-related information” refers to information describing an article to be packaged and shipped, including one or more attributes such as dimensional information, mass information, shape information, destination information, classification information, and any other attribute that characterizes the article for purposes of determining a packaging method.

The term “dimensional information” refers to data indicating one or more physical size measures of an article, such as length, width, height, diameter, or volume, expressed in one or more units of measure.

The term “mass information” refers to data indicating the mass or weight of an article, expressed in one or more units of measure such as grams, kilograms, or pounds.

The term “shape information” refers to data indicating the geometric or physical form of an article, such as whether the article is regular or irregular in shape, flat or bulky, fragile or robust, and may include descriptive text, categorical labels, or encoded values representing such characteristics.

The term “destination information” refers to data indicating a target delivery location for an article, such as a country, region, city, postal code, or address segment, that is relevant to determining shipping conditions or packaging requirements.

The term “product attribute information” refers to a set of product-related information items, including at least dimensional information, mass information, shape information, and destination information, and optionally additional attributes, represented in a structured form suitable for machine processing.

The term “user terminal” refers to an information processing device operated by a user, such as a personal computer, a mobile terminal, a tablet device, or another display-capable apparatus, that communicates with a server via a communication network and presents information to the user.

The term “communication network” refers to a wired or wireless data communication infrastructure, such as a local area network, a wide area network, or a public packet network, that enables information exchange between the server, the user terminal, and external information processing apparatuses.

The term “prompt sentence” refers to a sequence of natural language text, optionally combined with structured data, that is generated by the processor and provided as an input request to a generative AI model in order to cause the generative AI model to generate a response related to a packaging method or related content.

The term “generative AI model” refers to a machine-learned information processing model that, upon receiving an input including a prompt sentence, generates output information such as text, structured data, or other content, where the generation is based on statistical relationships learned from training data.

The term “response information” refers to information output by the generative AI model in response to a prompt sentence, including at least a proposed packaging method or recommendations related to packaging materials, packaging procedures, or handling instructions.

The term “packaging material” refers to a physical article or consumable material used to enclose, protect, cushion, seal, or label an article for shipping, such as a box, a container, a cushioning material, a protective film, an adhesive tape, or a label.

The term “packaging material candidate information” refers to data indicating one or more candidate types and quantities of packaging materials, derived from the response information of the generative AI model, and used as a basis to search for corresponding products in a commerce system.

The term “commercial transaction information processing apparatus” refers to an information processing system that manages product information, transaction processing, and related services for commercial activities, such as an electronic commerce platform server.

The term “application programming interface” refers to a defined interface specification, including one or more endpoints and associated protocols, that allows a program executed by the processor to request and receive data or services from an external information processing apparatus.

The term “product information” refers to information provided by the commercial transaction information processing apparatus and associated with a commercial item, including one or more attributes such as product name, category, specification, price, stock status, seller rating, and purchase URL.

The term “packaging material set” refers to a combination of two or more packaging materials selected to be used together for packaging an article, where the combination is constructed based on compatibility with the article's attributes and a proposed packaging method.

The term “recommended packaging material set information” refers to data describing one or more packaging material sets proposed by the processor, including constituent packaging materials, quantities, pricing information, and purchase identification information enabling acquisition of the packaging materials.

The term “purchase identification information” refers to information enabling initiation or execution of a purchase operation for one or more packaging materials through the commercial transaction information processing apparatus, such as a product identifier, a link to a purchase page, or an order parameter.

The term “work instruction information” refers to procedural information or guidance generated by the processor for performing a packaging method, including step-by-step instructions, ordering of operations, handling precautions, and references to specific packaging materials to be used.

The term “structured information” refers to information represented in a machine-readable format having defined fields or keys, such as a record, an object, or a table structure, which enables deterministic access and processing of individual data elements.

The term “evaluation information” refers to information indicating a user's assessment of a proposed packaging method, a recommended packaging material set, or system behavior, such as rating values, selection choices, or textual comments.

The term “feedback information” refers to information provided by a user or derived from user behavior that is used by the processor to modify, refine, or adapt processing parameters, including parameters for generating prompt sentences or for interacting with the generative AI model.

The term “input conditions for the generative AI model” refers to parameters and settings used when providing input to the generative AI model, including prompt sentence content, model identifier, temperature, maximum output length, formatting instructions, and any other control parameter affecting model behavior.

In one embodiment, a server, a terminal, and a generative AI model cooperate to implement the claimed system. The server executes a program on a hardware platform such as a general-purpose computing machine including a central processing unit, a volatile memory, a non-volatile storage device, and a network interface. The server runs an operating system such as a generic server operating system, and an application execution environment such as an interpreter or runtime for a scripting language (for example, a Python runtime with a web framework, or a JavaScript runtime with a server-side application framework). The terminal is implemented as an information processing device such as a personal computer, a mobile terminal, or a tablet device, executing a web browser or a dedicated client application. The generative AI model is implemented as a neural network model hosted either on the same server or on an external model serving apparatus accessible via a communication network. The server stores, in a non-volatile storage device, a program including modules for communication control, data validation, prompt sentence generation, generative AI interaction, result parsing, commerce platform interface control, packaging material set composition, and work instruction generation. The server also stores a data schema for representing product-related information as structured records, a configuration for mapping product attributes to packaging categories, and templates for constructing prompt sentences in natural language.

The terminal presents an input interface on a display device, such as a liquid crystal display or an organic light-emitting diode display, by executing client-side logic. The terminal accepts user input corresponding to dimensional information, mass information, shape information, and destination information of an article to be packaged. The terminal represents the input as a structured record, for example, as fields for numeric dimension values, numeric mass values, categorical shape descriptors, and destination codes. The terminal then transmits this structured record to the server via a communication network using a transport protocol such as hypertext transfer protocol over a secure channel.

The server stores the received product-related information in a memory structure, such as an object or row in a relational database. The server uses validation logic implemented in the application to verify that dimensional information and mass information fall within permitted numeric ranges, that shape information matches a controlled vocabulary or is mapped to such a vocabulary, and that destination information conforms to a predefined format. The server thereby prevents malformed or incomplete entries from propagating into subsequent processing stages. By normalizing and validating data at the server side, the system reduces error propagation and avoids unnecessary calls to the generative AI model, which improves processing efficiency and reduces communication load.

The server converts the validated product-related information into product attribute information by adding derived attributes. For example, the server calculates a volumetric size by performing arithmetic operations (multiplication) on the length, width, and height values, calculates a density value by dividing mass information by volumetric size, and assigns one or more category labels based on the combination of shape information and density value. The server stores these derived attributes in association with the original attributes in the memory. Such derived attributes serve as features that influence the content of the prompt sentence and the subsequent recommendations, thereby improving the precision of the system.

The server generates a prompt sentence in a natural language form by applying a template-based construction process. The server stores one or more prompt templates as text patterns with placeholders for attribute values. The server selects a template based on one or more category labels, and fills each placeholder with corresponding field values from the product attribute information. For example, the server may generate prompt sentences such as: “You are an expert in e-commerce logistics and packaging. Please propose an optimal packaging material set for safely shipping a fragile electronic device. The device dimensions are 30 cm×20 cm×10 cm and the weight is 1.2 kg. The destination is Tokyo, Japan. Include recommended box type, internal cushioning materials, and any special handling labels.”

“You are a professional packaging engineer. Propose a detailed packaging material set for a heavy mechanical component. The component dimensions are 50 cm×40 cm×30 cm and the weight is 20 kg. The shipment is domestic. Consider reinforced containers, internal supports, and any necessary palletization. Describe the reasoning for each material.”

By generating the prompt sentence from structured data according to explicit templates, the server ensures that essential attributes are consistently represented and that the generative AI model receives complete and disambiguated context. This reduces variability in the model's responses and decreases the need to repeat queries, thereby improving both response stability and computation efficiency.

The server passes the generated prompt sentence to the generative AI model via an application programming interface for model inference. In one embodiment, the generative AI model is a transformer-based neural network that has been trained on text corpora including technical descriptions of packaging methods and materials. The server specifies not only the prompt sentence but also model parameters such as model identifier, a temperature parameter controlling randomness, a maximum token length parameter, and formatting directives that instruct the model to produce a response with explicit sections or fields. The server includes, in some cases, a system-level meta-instruction within the prompt to ensure that the generative AI model outputs a semi-structured result with labels such as “box_type,” “box_size,” “cushioning_material,” and “special_instructions.”

Internally, the generative AI model represents the prompt sentence as a sequence of tokens and performs vectorized computations, including multi-head self-attention and feedforward operations, to generate a probability distribution over token sequences representing packaging instructions and material recommendations. The model weights have been obtained in a prior training process using an optimization method such as stochastic gradient descent with an error function such as cross-entropy loss. During training, the model adjusts weight matrices to minimize prediction error over a large dataset including correct packaging instructions paired with textual descriptions of article characteristics. In one embodiment, the training data is augmented by synthetic data expansion, where product dimensions and weights are perturbed within realistic ranges and associated packaging instructions are generated or curated. This training procedure yields a model that can correlate multi-dimensional product attributes with packaging methods in a way that is not trivially implementable by simple rule-based systems.

The server receives a text response from the generative AI model as part of an inference response message. In one embodiment, the server configures the generative AI model to output a response that includes explicit markers or delimiters around key data fields. The server then processes the text response using a parser that recognizes these markers and maps the segments into structured fields representing packaging material specifications, such as container type, internal dimensions, wall thickness class, cushioning material type, required thickness of cushioning layers, and recommended labels. The server may perform additional consistency checks over these fields, such as verifying that the recommended internal dimensions exceed the product dimensions by a configured clearance margin, and discarding or correcting inconsistent recommendations based on deterministic rules.

The server uses the structured fields obtained from the generative AI response to generate packaging material candidate information. The server converts qualitative descriptions like “double-wall corrugated box slightly larger than the device” into quantitative search ranges by applying mapping rules stored in configuration tables. For example, the server may map a product of 30 cm×20 cm×10 cm to a required box inner dimension range of 35 to 40 cm×25 to 30 cm×15 to 20 cm, using explicit arithmetic and configured clearances. The server may also map “bubble wrap with at least 5 cm thickness” to a minimum roll width and length needed for a specific number of wraps around the article. These mapping rules allow the system to convert high-level textual guidance into precise numeric filters.

The server communicates with a commercial transaction information processing apparatus, such as an electronic commerce platform backend, via an application programming interface. The server generates requests that include query parameters corresponding to the packaging material candidate information. For example, the server may specify a category code for boxes, a material code for reinforced cardboard, a range of internal dimensions, a minimum rating threshold, and price range limits. The server transmits these requests over a secure communication channel and receives product information records including item identifiers, names, dimensions, prices, and availability.

The server filters and ranks the returned products by comparing product attributes with the candidate ranges derived from the generative AI output. The server uses arithmetic comparisons and scoring functions to compute a compatibility score for each candidate material, taking into account dimensional fit, price deviation from a target, and quality indicators. The server selects, for each material type (such as box, cushioning material, label), one or more top-ranked candidates and composes packaging material sets by combining compatible items. The server calculates the total price and estimated weight of each packaging material set and discards sets that violate configured constraints, for example maximum budget or weight restrictions.

The server generates recommended packaging material set information as structured data that includes, for each set, constituent items, quantities, total cost, and purchase identification information such as deep links to purchase pages or item identifiers for cart creation. The server also generates work instruction information by merging the procedural guidance from the generative AI response with the concrete item identifiers of the selected materials. For example, the work instruction information may contain steps such as: placing a specific box on a work surface, applying a certain number of layers of a named cushioning product, positioning the article, filling voids with a specified cushioning product, closing and sealing the box with a specific tape, and attaching particular labels.

The terminal receives the recommended packaging material set information and the work instruction information from the server. The terminal parses the structured data and presents the sets and instructions on the display. The terminal may use graphical elements to indicate layer thickness, label positions, or orientation markers, based on coordinates or annotations included in the work instruction information. By presenting server-generated guidance tied directly to concrete material identifiers, the terminal assists the user in performing a packaging procedure that follows the generative AI-based design while remaining specific to the actually acquired materials.

In one embodiment, the server further collects evaluation information and feedback information from the user via the terminal. The user may rate the appropriateness of a given packaging material set, indicate whether the packaging procedure was easy to perform, or report damage outcomes in subsequent shipments. The server stores this feedback in association with the original product-related information, the prompt sentence used, and the generative AI response.

The server analyzes the feedback using statistical methods to adjust prompt construction templates or model call parameters. For instance, if certain categories of products repeatedly generate packaging methods that users rate poorly, the server may modify the template to emphasize particular requirements (such as stronger boxes or thicker cushioning) or may adjust model parameters to require more detailed explanations.

The server thereby implements a feedback loop that modifies how the generative AI model is invoked, rather than simply adjusting a high-level business rule. This improves the quality of future responses while limiting the need to retrain the core model. By analyzing feedback across multiple transactions, the server can identify systematic under-or over-estimation of material needs and can refine mapping rules and scoring functions. This yields technical effects such as reduced over-packaging (resulting in lower material and shipping costs) and reduced under-packaging (resulting in fewer damaged shipments), both of which can be quantified in terms of error rates in predictions versus observed outcomes.

The described architecture improves computer technology in several ways. First, by enforcing a structured transformation pipeline from numeric and categorical product attributes to natural language prompt sentences and back to structured packaging specifications, the server reduces ambiguity and non-determinism in the interaction with a generative AI model. This structured interaction decreases the number of required queries and mitigates the need for manual post-processing of unstructured model output, thereby reducing computational overhead and network traffic.

Second, by implementing explicit numeric conversions, range mappings, scoring functions, and constraint checks at the server level, the system avoids naive free-text processing and instead uses algorithmic decisions that are reproducible and optimized for throughput. This results in faster end-to-end processing for packaging recommendations and a lower probability of inconsistent or infeasible recommendations reaching the user.

Third, by incorporating user feedback into the prompt generation logic and the mapping rules, the system continuously tunes its internal control parameters and templates. This tuning improves the precision of the initial prompt sentences and reduces the variance of the generative AI responses. Consequently, the system reduces the need for re-queries and lowers the average processing time per transaction, enhancing the throughput capability of the server and improving resource utilization.

Fourth, the integration of the generative AI model with downstream commerce platform interaction and packaging instruction generation ensures that outputs of the model are directly tied to physical operations in the real world. The server does not merely display a text suggestion; it controls the computation of dimension ranges, selection of concrete materials from a commerce platform, and construction of instructions that guide the physical arrangement of materials around the article. This linkage between model output, algorithmic filtering, and physical execution yields a concrete improvement in the reliability and safety of physical shipments.

In alternative embodiments, the server may use different model architectures, such as a recurrent neural network or a hybrid model combining transformer layers with convolutional pre-processing, while still performing the described structured prompt generation and result parsing.

The server may also integrate a separate optimization module that uses integer programming or heuristic search to minimize total packaging cost or maximize protection score under constraints, using the generative AI output as an initial solution. The terminal may be implemented as an embedded device attached to a packaging workstation, and the work instruction information may trigger control signals to peripheral devices, such as printers for labels or actuators for automated tape dispensers, thereby further strengthening the link between the computational workflow and device control.

The user interacts primarily with the terminal interface, providing initial product-related information and reviewing recommended packaging material sets and instructions. The user may optionally override or confirm recommendations, and the terminal sends the corresponding signals back to the server. The server uses these user actions as part of the feedback information that informs subsequent system behavior. In this way, the user participates in a closed-loop system where server-controlled computational processes, generative AI inferences, and networked commerce operations cooperate to produce technically improved, data-driven packaging and shipping outcomes.

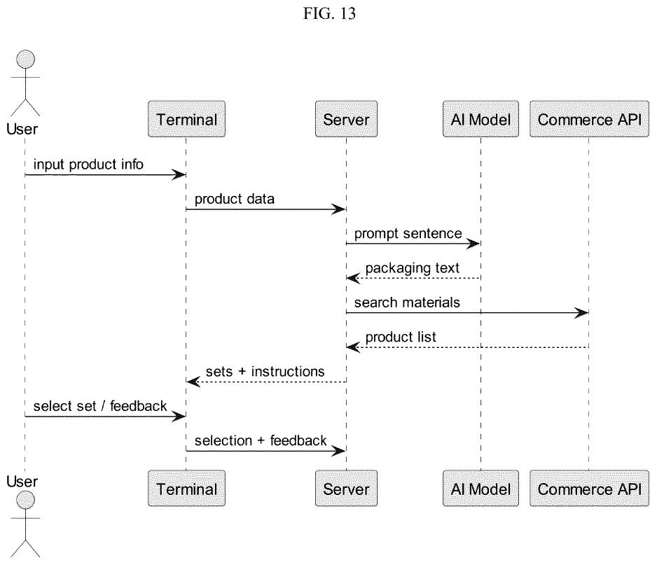

The following describes the processing flow using FIG. 13.

### Step 1:

User operates the terminal to input product-related information.

User views an input screen on the terminal and enters dimensional information (length, width, height), mass information, shape information, and destination information for an article to be packaged. User corrects errors indicated by the terminal until all required fields are filled.

Input: No prior data; user's knowledge about the article.

Output: A set of raw input values displayed on the terminal (text fields, selection values) before transmission.

### Step 2:

Terminal structures and validates the product-related information.

Terminal converts the raw input values into a structured record, for example assigning numeric fields for length, width, height, and mass, and string or coded fields for shape and destination. Terminal performs client-side checks, such as verifying that numeric fields contain only digits and that mandatory fields are non-empty. If validation fails, terminal displays error messages and requests correction from the user.

Input: Raw input values provided by the user.

Output: A structured product-information object in memory on the terminal, ready to be sent to the server.

### Step 3:

Terminal transmits the structured product-related information to the server.

Terminal serializes the structured object into a message format such as JSON and sends the message to a specified server endpoint over a secure communication protocol. Terminal includes metadata such as a session identifier or authentication token in the request headers.

Input: Structured product-information object on the terminal.

Output: A network request containing the structured product-related information delivered to the server.

### Step 4:

Server receives and parses the product-related information.

Server listens on a network interface for incoming requests and, upon receiving the message, parses the JSON payload into an internal data structure such as a record or object. Server verifies that all expected keys are present and that their types are compatible with the predefined schema. If parsing fails, server generates an error response and returns it to the terminal.

Input: Network request containing structured product-related information.

Output: An internal server-side product-information structure stored in memory or a database; optionally an error response to the terminal if parsing fails.

### Step 5:

Server validates and normalizes the product-related information.

Server performs range checks on dimensional values and mass values, confirming they are positive and within supported maxima. Server verifies that shape information matches or can be mapped to a controlled category list, and that destination information matches a permitted format or country/region list. Server converts units if necessary, for example converting inches to centimeters or pounds to kilograms using arithmetic operations.

Input: Parsed internal product-information structure.

Output: A validated and normalized product-attribute structure with consistent units and mapped categories.

### Step 6:

Server derives additional product attributes from the normalized data. Server calculates derived values such as volume by multiplying length, width, and height, and density by dividing mass by volume. Server assigns one or more category labels, such as “fragile electronics” or “heavy component,” based on combinations of shape, density, and size thresholds. Server stores these derived attributes along with the original attributes in a composite data object.

Input: Validated and normalized product-attribute structure.

Output: An enriched attribute object including original attributes and derived values (volume, density, category labels).

### Step 7:

Server selects a prompt template based on the enriched attributes.

Server examines category labels and other key fields to determine which prompt template to use. For example, if the article is labeled as fragile and electronic, server selects a template for fragile electronics; if heavy and industrial, server selects a template for heavy machinery. Server retrieves the corresponding text template from configuration storage.

Input: Enriched attribute object with category labels.

Output: A selected prompt template with placeholders for attribute insertion.

### Step 8:

Server generates a natural-language prompt sentence for the generative AI model.

Server fills placeholders in the selected template with concrete attribute values, formatting numeric values and destination details into human-readable text. Server may concatenate multiple template fragments and insert explanatory instructions to enforce a semi-structured response.

### Example Prompt Sentence:

“You are an expert in e-commerce logistics and packaging. Please propose an optimal packaging material set for safely shipping a fragile electronic device. The device dimensions are 30 cm×20 cm×10 cm and the weight is 1.2 kg. The destination is Tokyo, Japan. Include recommended box type, internal cushioning materials, and any special handling labels.”

Input: Selected prompt template and enriched attribute object.

Output: A finalized prompt sentence text string ready to be sent to the generative AI model.

### Step 9:

Server sends the prompt sentence and model parameters to the generative AI model.

Server constructs a request payload including the prompt sentence, a model identifier, and control parameters such as maximum output length, temperature, and required response format. Server transmits the payload to a model serving interface via a network protocol.

Input: Prompt sentence and model-control parameters.

Output: A model-inference request delivered to the generative AI model service.

### Step 10:

Server receives and extracts the response information from the generative AI model. Server obtains a response message containing the model's generated text. Server extracts the main text portion from the response structure and stores it as response information. If the response includes explicit markers or segments, server isolates each segment for further parsing.

Input: Response message from the generative AI model.

Output: A raw text response representing a proposed packaging method and related recommendations.

### Step 11:

Server parses the raw text response into structured packaging specifications.

Server applies parsing rules or pattern recognition to identify sections corresponding to box type, box size, cushioning materials, number of wrapping layers, void-filling materials, and special labels. Server may search for keywords and numeric values, and may rely on delimiters requested in the prompt sentence. Server maps each identified element into a structured field, such as “container_type,” “inner_dimensions,” “cushioning_type,” and “label_text.”

Input: Raw text response from the generative AI model.

Output: A structured packaging-specification object with discrete fields for each recommended packaging element.

### Step 12:

Server converts packaging specifications into packaging material candidate information.

Server applies conversion rules to map qualitative recommendations into quantitative requirements. For example, server increases each dimension of the article by a specified clearance margin to compute a required internal box size range, and calculates minimum cushioning material length and thickness from the number of layers and article perimeter. Server records these numeric ranges and material categories as candidate information.

Input: Structured packaging-specification object.

Output: Packaging material candidate information including numeric size ranges, material categories, and required quantities.

### Step 13:

Server constructs and sends search queries to a commercial transaction information processing apparatus.

Server translates candidate information into query parameters for an external application programming interface, including category codes, size ranges, material types, minimum ratings, and price constraints. Server sends one or more query messages to the commerce apparatus, each targeted at a specific material category such as containers, cushioning materials, or labels.

Input: Packaging material candidate information.

Output: API requests containing search parameters transmitted to the commercial transaction information processing apparatus.

### Step 14:

Server receives and filters product information from the commercial transaction information processing apparatus.

Server obtains response messages including lists of product records, each with attributes such as name, dimensions, price, rating, and availability. Server discards items that fall outside the required size ranges or that are unavailable. Server computes a compatibility score for the remaining items, for example by measuring closeness of item dimensions to target dimensions and normalizing price relative to a preferred budget.

Input: Product information records from the external commerce API.

Output: Filtered and scored product-candidate lists for each material category.

### Step 15:

Server composes packaging material sets from filtered candidates.

Server selects top-ranked items in each category and combines them into candidate packaging material sets. Server ensures that each set contains at least one container, one or more cushioning materials, and any required labels. Server calculates the total cost and estimated packaging weight for each set by summing individual item prices and weights.

Input: Filtered and scored product-candidate lists.

Output: A collection of packaging material sets with computed total costs and associated item lists.

### Step 16:

Server generates recommended packaging material set information.

Server transforms each packaging material set into a structured description including item names, identifiers, quantities, prices, and purchase identification information such as purchase URLs or item codes. Server adds metadata such as an overall rating for each set and an explanation derived from the packaging-specification object, so that the user understands why specific items are chosen.

Input: Collection of packaging material sets with computed metrics.

Output: Recommended packaging material set information suitable for transmission to the terminal.

### Step 17:

Server generates work instruction information linked to concrete materials.

Server merges the procedural description from the parsed packaging specifications with the selected concrete materials. For example, server replaces generic references such as “double-wall box” with the specific item name and identifies how many layers of a particular cushioning product to apply. Server sequences the instructions and adds clarifying text to indicate orientation, labeling positions, and sealing steps.

Input: Structured packaging-specification object and recommended packaging material set information.

Output: Detailed work instruction information referencing specific purchased or purchasable items.

### Step 18:

Server transmits recommended packaging material set information and work instruction information to the terminal.

Server encapsulates both sets of data into a response message, typically in a structured format such as JSON, and sends the message to the terminal via the communication network. Server may also include status codes and a summary of main recommendations to allow rapid rendering on the terminal.

Input: Recommended packaging material set information and work instruction information.

Output: A server response message delivered to the terminal containing recommendations and instructions.

### Step 19:

Terminal parses and displays the recommendations and instructions to the user.

Terminal receives the response message, parses the structured content, and constructs a user interface presenting the available packaging material sets, their prices, and their key characteristics. Terminal simultaneously displays or provides access to the work instruction information, possibly with step-by-step guides or diagrams.

Input: Server response message containing recommended packaging material set information and work instruction information.

Output: A rendered user interface on the terminal display, showing selectable packaging material sets and corresponding instructions.

### Step 20:

User reviews the recommended sets and issues feedback or selection.

User examines the displayed packaging material sets and associated work instructions, selects one or more preferred sets, and may submit evaluation information such as satisfaction ratings or textual comments. User optionally initiates a purchase by activating a control element on the terminal.

Input: Displayed recommendations and work instructions.

Output: User selection signals and optional feedback data entered into the terminal.

### Step 21:

Terminal sends user selection and feedback to the server.

Terminal packages the selected set identifiers and any feedback values into a structured message and sends it to the server. Terminal may also redirect the user to a purchase page by opening the purchase URL associated with the chosen set.

Input: User selection signals and feedback data.

Output: A selection-and-feedback message transmitted to the server, and an optional navigation action to an external purchase interface.

### Step 22:

Server updates internal records and prompt-generation parameters based on feedback.

Server receives the selection-and-feedback message, associates the feedback with the original product-related information, prompt sentence, and generative AI response, and stores this association in persistent storage. Server analyzes the accumulated feedback over time to adjust prompt templates, template-selection rules, or generative AI model parameters. For example, server may increase emphasis on cushioning thickness in prompt text if user feedback indicates frequent dissatisfaction with protection.

Input: Selection-and-feedback message containing user evaluations and set identifiers.

Output: Updated configuration data and refined prompt-generation parameters that influence future prompt sentences and subsequent system behavior.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional packaging support services largely function as static content delivery systems that present generic packaging recommendations and material lists without leveraging detailed product attributes, real-time market data, or user-specific emotional context. From a computer-technology perspective, these conventional systems suffer from several technical deficiencies.

First, a typical system does not integrate heterogeneous data streams such as structured product information from electronic transaction platforms, unstructured product image data, and dynamic inventory and pricing information from logistics systems into a unified processing pipeline. As a result, the system is unable to compute packaging recommendations that are both technically appropriate for the product and constrained by actual stock availability, special pricing, and logistics conditions. This leads to inefficient use of computing resources, frequent user-driven trial-and-error searches, and repeated client-server interactions, thereby increasing network traffic and server load.

Second, conventional systems treat generative AI models, when used at all, as generic text generators. They do not construct prompt sentences in a way that encodes machine-relevant state, such as precise dimensions, mass, breakage risk, and delivery constraints, nor do they adapt the prompt design based on historical interaction data or user emotional state. This results in unstable output quality, increased post-processing on the server, and redundant calls to the generative AI model, which in turn degrades latency and predictability of the overall information processing pipeline.

Third, known systems do not computationally exploit user emotion signals as a structured input to the packaging-support logic. Emotion is often ignored or handled outside the core processing flow. As a consequence, the server cannot algorithmically tune instruction detail level, presentation order, or emphasis based on user anxiety or confusion. The computing system therefore fails to reduce repeated user queries, user abandonment, and the need for manual support, which would otherwise be alleviated by dynamically adapting content granularity.

Fourth, in logistics facilities and high-volume environments, packaging material selection and ordering are frequently decoupled from real-time inventory and special-price information. Existing systems typically require separate tools for material ordering and for packaging guidance. This fragmentation forces redundant data retrieval and manual reconciliation of stock status, thereby increasing processing steps in the server, increasing data inconsistency, and making it difficult to algorithmically optimize ordering and inventory management using the same core computational pipeline that generates packaging recommendations.

Accordingly, there is a need for an improved computer-implemented system that: (i) unifies acquisition and processing of product data, image data, transaction data, and inventory data; (ii) automatically generates and refines prompt sentences for a generative AI model based on detailed product attributes, user emotional state, and accumulated histories; (iii) programmatically selects packaging resources in view of both AI-generated proposals and machine-readable stock and price data; and (iv) dynamically generates and adapts packaging support content on user terminals based on computed emotional states. Such a system should reduce redundant AI calls, lower server and network load, improve response determinism, and provide a more efficient and technically robust packaging-support workflow at scale.

The specific processing by the specific processing unit 290 of the data processing device 12 in Application Example 2 is realized by the following means.

The present invention provides a server comprising a processor configured to acquire, via communication interfaces, product information, product images, user information, emotional state information of a user, electronic transaction information, inventory information, and special price information from a plurality of data sources; to execute image analysis processing on the product images to extract product attributes including dimensions, mass, shape, and breakage risk; to execute emotion analysis processing on the emotional state information of the user to determine an emotional state classification and associated confidence values; to generate a prompt sentence that encodes, in a machine-interpretable natural-language structure, conditions relating to a packaging method and packaging resources based on the extracted product attributes, the determined emotional state classification, and the electronic transaction information; to input the generated prompt sentence into a generative AI model via an application programming interface and receive, in response, a proposal result including a candidate packaging method and candidate packaging resources; to collate the proposal result with packaging resource information stored in a storage unit and with transaction information stored in a storage unit, and to algorithmically select recommended packaging resources by applying constraints derived from the inventory information and the special price information; to generate packaging support content including stepwise packaging instruction information, explanation text, diagram information, and video information based on the proposal result and the determined emotional state classification, such that a detail level, presentation order, and emphasis of the packaging support content are programmatically varied according to the emotional state classification; to deliver the packaging support content and the selected recommended packaging resources to a user terminal and to enable, via the electronic transaction platform, execution of a purchase process for the recommended packaging resources; and to record, in association with user identifiers, an order history of packaging resources, a usage history of the packaging support content, and the emotional state classifications, and to update, using the recorded histories, generation conditions of the prompt sentence and logic used to process the proposal result from the generative AI model. This enables the computing system to perform, with reduced redundant processing and improved determinism, an integrated packaging-support workflow in which heterogeneous data sources are fused into a coherent AI-assisted decision pipeline, prompts to the generative AI model are automatically optimized based on historical and emotional context, packaging resources are selected in real time under inventory and pricing constraints, and user-facing guidance is dynamically adapted to user state, thereby improving overall efficiency, scalability, and technical performance of the packaging-support service.

The term “processor” refers to a hardware and/or software computation unit, including at least one central processing unit, microcontroller, or programmable logic device, that executes instructions to perform data acquisition, data analysis, prompt generation, model communication, selection logic, and content generation as described herein.

The term “product information” refers to structured or semi-structured data describing a product, including at least one of dimensions, mass, shape, category, material, fragility, price, and delivery conditions, obtained from an electronic transaction platform or another data source.

The term “product image” refers to digital image data representing visual information of a product, acquired via an imaging device such as a camera or scanner and provided to the server for analysis.

The term “product attributes” refers to one or more characteristics of a product derived from product information and/or a product image, including at least one of size, geometry, material, estimated breakage risk, and packaging requirements.

The term “user information” refers to data associated with a user of the system, including at least one of a user identifier, profile data, interaction history, and preferences.

The term “emotional state of a user” refers to a classification of the user's affective condition, such as anxiety, confusion, joy, or excitement, determined by processing sensory data including facial images, audio signals, or interaction patterns.

The term “electronic transaction information” refers to data generated or managed by an electronic transaction platform, including at least one of order records, product listings, pricing data, discount conditions, and purchase status.

The term “inventory information” refers to data indicating availability, quantity, and storage state of packaging resources or other items in one or more storage locations or logistics facilities.

The term “special price information” refers to data representing discounted or preferential pricing conditions for packaging resources, including temporary promotions, bulk discounts, or customer-specific offers.

The term “prompt sentence” refers to a natural-language or structured text string that encodes conditions and constraints relating to a packaging method and packaging resources, and that is input to a generative AI model to cause the model to output a proposal result.

The term “generative AI model” refers to a trained information processing model, implemented in software and/or hardware, that generates output data such as text in response to input data including a prompt sentence, and that uses statistical or machine learning techniques to produce context-dependent results.

The term “proposal result” refers to output data from the generative AI model that includes at least one candidate packaging method and at least one candidate packaging resource corresponding to a given prompt sentence.

The term “packaging resources” refers to physical items used for packaging a product, including at least one of containers, cushioning materials, protective elements, sealing materials, and labels.

The term “recommended packaging resources” refers to a subset of packaging resources selected by the processor based on the proposal result from the generative AI model and on constraints including inventory information and special price information.

The term “packaging resource information storage unit” refers to a logical or physical storage component, such as a database or memory, that stores data describing available packaging resources, including types, dimensions, material properties, and identifiers.

The term “transaction information storage unit” refers to a logical or physical storage component that stores electronic transaction information, including order histories, pricing records, and customer-specific conditions.

The term “electronic transaction platform” refers to a network-accessible system that enables electronic purchase, sale, or management of goods or services, and provides an interface for submitting purchase requests and receiving transaction information.

The term “information providing unit of an electronic transaction platform” refers to an interface, such as an application programming interface or web service, provided by the electronic transaction platform and configured to supply transaction-related data or accept purchase-related requests.

The term “packaging support content” refers to digital content that assists a user in performing packaging of a product, including at least one of stepwise instructions, explanation text, diagram information, and video information.

The term “instruction information” refers to ordered and machine-generated descriptive data specifying operations, sequences, and conditions for executing a packaging method.

The term “user information terminal” refers to an end-user device, such as a mobile terminal, personal computer, or other communication device, capable of receiving, displaying, or playing back packaging support content and interacting with the server.

The term “order history of packaging resources” refers to recorded data describing past purchase or usage events of packaging resources by one or more users or logistics facilities.

The term “usage history of the packaging support content” refers to recorded data describing when, how, and to what extent users have accessed, viewed, or interacted with the packaging support content.

The term “generation conditions of the prompt sentence” refers to parameters, templates, and rules used by the processor to construct a prompt sentence, including which product attributes, emotional state elements, and transaction details are encoded into the prompt sentence.

The term “packaging method proposal logic” refers to computational rules, algorithms, and selection criteria applied by the processor to interpret the proposal result from the generative AI model and to decide how to map the result into concrete packaging methods and recommended packaging resources.

The term “logistics facility” refers to a physical or virtual site used for storage, handling, or distribution of goods, including warehouses, fulfillment centers, and distribution hubs.

In one embodiment, a server, one or more terminals, and at least one networked data storage unit cooperate to implement the claimed system. The server includes at least one processor, a main memory, a non-volatile storage device, and a network interface. The processor executes a packaging-support program stored in the non-volatile storage device. The terminals include user-operated computing devices such as smartphones, tablet computers, or personal computers equipped with a display, a camera, a microphone, and a wireless or wired communication interface.

Server executes an operating system and middleware such as a web server and an application server. Server executes a database management system such as a relational database engine to manage product information, transaction information, inventory information, packaging resource information, usage histories, and emotion-analysis results. Server executes one or more machine learning libraries and image-processing libraries such as a deep-learning framework and an image-processing toolkit. Server communicates with at least one generative AI model hosted either on the same hardware or on a remote machine via an application programming interface. Terminal executes an operating system and an application, which may be a native application or a browser-based application. Terminal uses hardware components including the camera, microphone, touch screen, and graphics controller. Terminal communicates with the server using secure data transfer protocols to send captured images and audio, and to receive packaging support content including text, diagrams, and video.

Server uses a modular software architecture. Server includes at least: (i) a data acquisition module, (ii) an image analysis module, (iii) an emotion analysis module, (iv) a prompt construction module, (v) a generative-model communication module, (vi) a packaging resource selection module, (vii) a content generation module, and (viii) a history and adaptation module. These modules are implemented as computer-executable components that exchange data through structured data objects, database tables, and message queues.

Server uses specific data structures to represent product information. Server stores, for each product, a product record including at least a product identifier, category identifier, length, width, height, mass, material type, fragility score, and default shipping method. Server stores product images in an image storage unit and maintains metadata records indicating resolution, capture device, and associated product identifier.

Server uses an image analysis module to transform raw product images into product attributes.

Server loads each product image as a multi-channel pixel array and applies a convolutional neural network (CNN) to detect the primary object and estimate its bounding box and orientation. In one embodiment, the CNN includes multiple convolutional layers, pooling layers, and fully connected layers trained on labeled packaging scenarios. Server computes shape descriptors such as aspect ratio, contour complexity, and estimated protruding regions. Server combines these descriptors with metadata such as category and historical damage rates to assign a numeric breakage-risk score to each product. Server writes these product attributes into a product attribute table in the database.

Server uses an emotion analysis module to derive an emotional state of the user from facial images and/or audio. Server receives, from the terminal, image frames of the user's face and optionally audio samples of the user's voice. Server applies a separate CNN for facial expression recognition and, optionally, a recurrent neural network or transformer-based model for prosody analysis. Server computes a probability distribution over predefined emotional labels such as “anxiety,” “confusion,” “joy,” and “excitement.” Server selects the label with the highest probability as the emotional state and stores both the label and confidence vector in an emotion table linked to the user identifier and session identifier.

Server uses a generative AI model implemented as a sequence-to-sequence neural network, which may be a transformer-based language model. The generative AI model includes an embedding layer, multiple self-attention blocks, feed-forward layers, and a final projection layer that outputs token probabilities. The generative AI model is trained, in advance, on packaging instructions and logistics-related texts using a supervised learning regime. During training, server or a training system minimizes a loss function such as cross-entropy between generated tokens and ground-truth tokens. The training system updates model parameters using an optimization algorithm such as stochastic gradient descent with adaptive learning rate. The training system may augment text data by synthesizing paraphrased instructions and perturbing numeric values within valid ranges to improve robustness.

Server uses the prompt construction module to transform machine-readable state into a prompt sentence suitable for the generative AI model. Server reads product attributes including dimensions, mass, shape, breakage risk score, and default shipping method. Server reads the user's emotional state and confidence. Server reads relevant transaction information including order date, destination region, and any shipping constraints. Server applies a template-based rule system to embed these values into natural-language text. For example, server constructs prompt sentences such as:

“The user bought a 15-inch laptop with dimensions 35 cm by 24 cm by 2 cm and weight 1.8 kg. The user appears anxious about possible damage during standard courier shipping. Propose a detailed, step-by-step packaging method and list specific packaging materials, including any recommended double boxing, that minimize breakage risk.”

or

“This product is a fragile glass vase approximately 30 cm tall and 10 cm in diameter. Please propose a packaging method that uses abundant cushioning material and double boxing, and list the necessary packaging materials.”

Server optionally adds meta-instructions to the prompt sentence such as: “Use concise numbered steps. Indicate minimum cushioning thickness in centimeters.”

Server uses the history and adaptation module to modify prompt templates over time. Server analyzes historical logs of prompt sentences, generative outputs, user selections, and subsequent incident reports such as reported breakage. Server computes statistics correlating certain prompt patterns with successful outcomes such as reduced breakage and fewer user follow-up queries.

Server adjusts prompt templates by, for example, always including explicit warnings for categories with historically high damage rates, or by requesting more detailed explanations in scenarios where emotion analysis frequently detects anxiety.

Server uses the generative-model communication module to send the constructed prompt sentence to the generative AI model. Server configures model parameters such as temperature, top-k sampling values, and maximum output length according to task type. For safety-critical packaging cases such as high-fragility products, server uses a lower temperature to reduce variance in results and improve determinism. Server receives the output text from the generative AI model and parses it using syntactic and semantic pattern matching to identify packaging steps and candidate packaging resources.

Server uses the packaging resource selection module to map candidate packaging resources from the generative text to actual stock-keeping units in the packaging resource database. Server employs a rule-based matching algorithm that associates natural-language descriptions such as “double-wall cardboard box slightly larger than the laptop” or “3 cm bubble wrap layer” with database records describing box dimensions, wall thickness, and bubble wrap roll specifications.

Server computes, for each candidate combination, a feasibility score based on whether the product and required cushioning can fit into a candidate box with required clearance. Server further incorporates inventory information and special price information into the feasibility calculation by penalizing items with low stock or no discount and favoring items with abundant stock and discount availability.

Server stores packaging resource information in a packaging resource table including columns for internal identifier, type (box, cushioning, tape, protector), physical dimensions, material specification, protection rating, stock quantity, base price, and special price fields. Server stores inventory information received from logistics systems or warehouse management systems.

Server stores special price information including start time, end time, discount rate, and eligible customer segments.

Server uses a scoring function to rank candidate sets of packaging resources. The scoring function may blend breakage risk reduction, total material cost, inventory adequacy, and user-emotion-based preferences. For example, server assigns higher weight to breakage-risk reduction for anxious users and higher weight to cost savings for neutral or cost-sensitive users.

Server selects the highest-scoring set as recommended packaging resources. Server writes the selected set to a recommendation table associated with the product and user.

Server uses the content generation module to assemble packaging support content. Server transforms generative AI output and selection results into structured content objects containing stepwise instructions, explanation text, diagram specifications, and film-strip specifications for video. Server may call a separate generative model to rewrite instructions to a specific reading level or to a different language while preserving machine-interpretable markers for steps and warnings. Server creates diagrams by generating vector graphics commands, for example, to represent a box, wrap layers, and labeled arrows. Server can use a vector-graphics tool or graphics library running on the server to materialize these diagram specifications into image files.

Server generates video content by combining diagram frames and text overlays into a timeline.

Server uses a video processing library or a video editing engine to compose frames at a predetermined frame rate, add text captions, and, optionally, include synthesized narration.

Server stores the resulting video files in a content storage system and records metadata linking each video to corresponding product categories, packaging resources, and user segments.

Terminal receives packaging support content from the server. Terminal caches text instructions and diagrams and streams video content on demand. Terminal uses user interface components to present instructions in a layout adapted to user context and emotional state. For an anxious user, terminal may present a larger font, explicit warning icons, and slower video playback by default. For a confident or experienced user, terminal may present a condensed checklist.

Terminal collects user interactions such as scrolling, pausing, rewinding specific segments, and toggling detailed explanations. Terminal sends these interaction events back to the server. Server uses these events to update the usage history and to further refine prompt templates and selection logic.

Server interacts with an electronic transaction platform to enable purchase of packaging resources. Server constructs structured transaction requests including selected packaging resources, quantities, and shipping addresses. Server transmits the requests through a transaction interface such as a RESTful API. Server processes transaction responses and updates order history records. Terminal displays order confirmation and, where supported, allows the user to review or modify created orders.

In a logistics facility scenario, server additionally integrates a warehouse application on the terminal. Server provides a view optimized for high-volume ordering and inventory management. Server uses the same resource selection logic but receives additional constraints such as required daily throughput and storage limits. Server computes suggested reorder quantities and reservation allocations based on current inventory, pending orders, and special price windows. Terminal displays these suggestions and allows warehouse staff to confirm or adjust them.

Server achieves technical improvements over conventional systems by the combination of data structures, algorithms, and neural-network-based modules. Because server encodes detailed product attributes and user emotional context into the prompt sentence, the generative AI model receives rich machine-interpretable conditions. This reduces the number of iterations needed to obtain a usable packaging method and lowers the need for manual corrections by server logic. The structured scoring and mapping algorithm substantially reduce irrelevant or infeasible packaging recommendations, thereby reducing computational waste in matching and inventory verification.

The described architecture improves processing speed because server avoids repeated, unstructured queries to the generative AI model. Instead, server uses a deterministic template-and-history-based prompt construction method, which results in more predictable output and reduces downstream parsing complexity. The use of explicit product-attribute fields and precomputed fragility scores allows server to quickly filter candidate boxes and cushioning without iterating over the full inventory. This decreases query time against the packaging resource database and reduces overall latency.

In terms of accuracy, server directly models breakage risk and associates it with product attributes and historical damage data. This results in a consistent mapping between product type and packaging method that is not achievable by simple human-authored generic guides. The emotion-aware adaptation further reduces miscommunication: anxious users receive more detailed and redundant guidance, which demonstrably reduces errors in executing steps, and consequently reduces shipping damage incidence.

Server improves communication efficiency by structuring data exchanges. Instead of transmitting large unfiltered catalogs, server sends only selected packaging resource data and compressed multimedia content to the terminal. Terminal sends compressed images, selectively sampled emotion frames, and sparse interaction events. These design choices reduce bandwidth consumption and avoid overloading network resources, which is particularly beneficial when many terminals are active concurrently.

The use of a generative AI model is not a mere automation of human drafting. The model operates within a tightly constrained computational framework defined by the prompt sentence, structured features, and scoring algorithms. Server applies rules and weights that may not be intuitive to a human packer, such as optimization of trade-offs among stock availability, discount windows, fragility, and user emotion. The model, trained with augmented data and guided by machine-selectable templates, generates content tailored to machine parsing and further optimization rather than only human readability.

In another embodiment, server uses alternative neural architectures. The generative AI model may be a recurrent neural network with attention mechanisms, or a hybrid architecture combining retrieval from a structured knowledge base with neural text generation. The emotion analysis module may use a graph convolutional network to model relationships between facial landmarks, or may rely solely on audio features when visual input is unavailable. The image analysis module may be replaced by a three-dimensional reconstruction algorithm when depth images are captured by the terminal.

In yet another embodiment, server processes only a subset of the described inputs. For products with well-known attributes directly provided by the electronic transaction platform, server may omit product image analysis and rely solely on structured product information. For terminals in environments where emotion detection is prohibited or infeasible, server may use only usage histories and interaction patterns to approximate user state, while still applying the same adaptation logic to prompt construction and content generation.

Through these various embodiments, server, terminal, and user cooperate in a technically specific way that leverages generative AI models and prompt sentences to achieve improved computation of packaging methods and selection of packaging resources. The system as a whole provides not only business-level workflow support but also concrete improvements in data management, algorithmic efficiency, and content personalization at the level of computer technology.

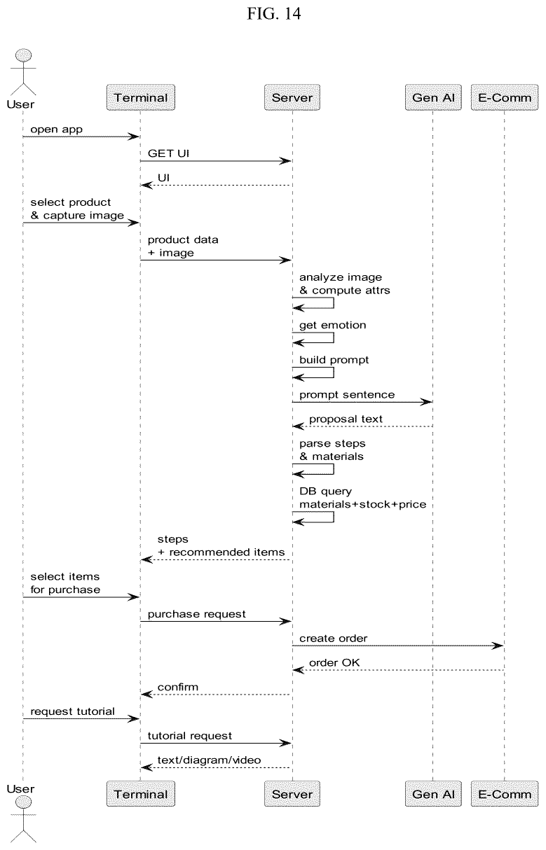

The following describes the processing flow using FIG. 14.

### Step 1:

Server initializes modules and loads configuration.

Server reads configuration files from storage to load model endpoints, database connection strings, and prompt templates.

Input: configuration data stored in files or environment variables.

Output: in-memory configuration objects defining API URLs, database schemas, and template structures.

Server parses the configuration data and creates data structures (for example, dictionaries and objects) in memory to be referenced by subsequent modules.

### Step 2:

User accesses the packaging-support application on the terminal.

User launches a browser or native application and navigates to the packaging-support screen.

Input: user interaction on the terminal (tap on application icon or URL).

Output: an HTTP request from the terminal to the server requesting the initial UI.

Terminal constructs an HTTP GET request and sends it to the server over a network connection.

### Step 3:

Server delivers the initial user interface to the terminal.

Server receives the HTTP request and returns HTML, CSS, and JavaScript resources or an API response for the native app.

Input: initial HTTP request containing user session or identifier.

Output: UI resources that define buttons such as “Use purchase history,” “Upload product image,” and “Start packaging advice.”

Server executes template rendering or static file serving and includes session tokens and localization settings in the response.

### Step 4:

User chooses a product to be packaged.

User selects a purchased product from a list or enters product information manually on the terminal.

Input: display of product list or input form on the terminal screen.

Output: a selection event or filled form data representing a target product.

Terminal collects selected product ID or entered attributes and prepares them for transmission.

### Step 5:

Terminal acquires and sends product information and product images to the server.

Terminal optionally requests purchase history from the server and opens the device camera for capturing a product image.

Input: product selection data, captured product image, and optional basic product attributes entered by the user.

Output: an HTTP POST request containing structured product information and encoded image data.

Terminal encodes the image as a compressed file, attaches metadata such as resolution and capture time, and sends both the structured data and the image to a dedicated server endpoint.

### Step 6:

Server stores raw product data and images.

Server receives the product information and the image, validates formats, and writes them to storage.

Input: structured product information and binary image data from the terminal.

Output: database records in product and image tables, and stored image files in an image storage unit.

Server assigns internal identifiers to the product and image, and updates a mapping table that links user ID, product ID, and image file path.

### Step 7:

Server analyzes the product image to extract product attributes.

Server applies an image-processing pipeline using a convolutional neural network to detect the product region and estimate dimensions and shape cues.

Input: stored image file and associated metadata.

Output: numerical product attributes such as estimated length, width, height, aspect ratio, and a shape descriptor.

Server loads the image into memory, resizes it to a standard resolution, normalizes pixel values, and forwards the image tensor through the neural network to obtain bounding boxes and classification outputs, then computes and stores derived attributes in a product attribute table.

### Step 8:

Server computes a breakage-risk score for the product.

Server combines image-derived attributes with any structured product information to estimate fragility.

Input: product attributes (shape, dimensions, material class) and known category data (for example, “electronics,” “glassware”).

Output: a breakage-risk score represented as a numeric value and a risk class such as “low,” “medium,” or “high.”

Server applies a trained risk-prediction model or rule set that weighs factors such as material type, slenderness ratio, and historical damage statistics, then writes the score to the database.

### Step 9:

Terminal captures and sends user emotion-related data.

Terminal activates the front camera and optionally the microphone, with user consent, and captures frames of the user's face and short audio segments.

Input: user presence and consent, along with video and audio capture capabilities.

Output: encoded face images and optional audio feature data sent to the server in an HTTP request.

Terminal periodically samples frames, compresses them, and transmits them to the server along with a session identifier.

### Step 10:

Server analyzes the emotional state of the user.

Server applies a facial expression model and, when available, a speech prosody model to classify the user's emotional state.

Input: face image data and audio features associated with the current session.

Output: an emotion label (for example, “anxiety,” “joy,” “confusion”) and a probability distribution over possible labels.

Server normalizes input images, extracts facial landmarks, feeds them into a trained neural network, calculates output probabilities for each emotion class, selects the dominant label, and stores the label and probabilities into an emotion table.

### Step 11:

Server aggregates product attributes, risk information, and emotional state.

Server reads the latest records for the target product and user session from the database.

Input: product attributes, breakage-risk score, user emotion label, and transaction information such as shipping method.

Output: a combined context object containing all data required to build a prompt sentence.

Server constructs a structured in-memory representation that includes fields for dimensions, mass, material, risk class, delivery constraints, and emotional state.

### Step 12:

Server generates a prompt sentence for the generative AI model.

Server uses the combined context object and prompt templates to construct a detailed natural-language instruction.

Input: combined context object and stored prompt templates.

Output: a prompt sentence containing descriptive text and explicit packaging constraints.

Server fills template placeholders with numeric values and labels, and may produce a prompt sentence such as:

“The user bought a fragile glass vase approximately 30 cm tall and 10 cm in diameter with high breakage risk. The user appears anxious about shipping. Propose a step-by-step packaging method using appropriate cushioning thickness and double boxing, and list the specific packaging materials needed.”

### Step 13:

Server sends the prompt sentence to the generative AI model and receives a proposal result.

Server invokes a generative AI model endpoint with the constructed prompt sentence and configuration parameters.

Input: prompt sentence, model selection, temperature setting, and maximum token limit.

Output: generated text containing a candidate packaging method and descriptions of packaging resources.

Server formats the prompt in a request payload, sends it through an API call, receives tokenized output, and reconstructs it into human-readable paragraphs or lists.

### Step 14:

Server parses the proposal result into structured steps and resource candidates.

Server analyzes the generated text to identify discrete packaging steps and mentions of specific materials.

Input: raw generated text from the generative AI model.

Output: a list of packaging steps and a set of candidate packaging resource descriptors (for example, “double-wall box,” “3 cm bubble wrap,” “corner protectors”).

Server uses pattern matching, keyword dictionaries, and sentence segmentation to split the text and to map phrases to internal resource categories.

### Step 15:

Server maps candidate resource descriptors to database records.

Server searches the packaging resource database for items matching the descriptors in type and size.

Input: candidate resource descriptors and resource database records.

Output: a set of matched resource records including identifiers, dimensions, and base prices.

Server executes parameterized database queries that filter resources by type, minimum required dimension, and protection rating, and constructs a mapping list between descriptors and concrete items.

### Step 16:

Server incorporates inventory information and special price information.

Server retrieves current stock levels and discount conditions for the matched resources.

Input: matched resource records, inventory table, and special price table.

Output: enriched resource records including available quantity and effective price.

Server performs join operations across tables and computes final prices by applying discount rules and considering valid time windows.

### Step 17:

Server selects recommended packaging resources based on scoring.

Server applies a scoring function that evaluates likely protection, cost, availability, and user emotion.

Input: enriched resource records, breakage-risk score, and emotion label.

Output: a ranked list and a final recommended set of packaging resources.

Server computes scores for candidate combinations, weighs risk reduction higher when the risk score is high or the user is anxious, and selects the combination with the highest score as the recommendation to be presented.

### Step 18:

Server generates user-facing packaging support content.

Server transforms packaging steps and recommended resources into structured instructions, diagrams, and video specifications.

Input: packaging steps, selected resources, and emotion label.

Output: packaging support content objects containing text instructions, diagram metadata, and video generation parameters.

Server adjusts detail level and ordering of steps according to emotion; for anxious users, server adds more explanatory text and explicit warnings, while for confident users, server condenses steps into checklists. Step 19: Server delivers packaging support content and recommendations to the terminal. Server constructs a response payload that includes recommended resource details and the associated instructional content.

Input: packaging support content objects and selected resource set.

Output: a response message containing resource lists, textual instructions, URLs for diagrams and videos, and flags for special prices.

Server serializes the content in a structured format and sends it via HTTP to the terminal.

### Step 20:

Terminal displays the recommendations and instructions to the user.

Terminal receives the response, renders the resource list, and shows step-by-step instructions and media.

Input: response message from the server containing content data and media locations.

Output: graphical user interface elements presenting recommended resources and packaging steps on the display.

Terminal loads diagrams and videos using the provided URLs, creates buttons such as “Buy now” or “Play tutorial,” and arranges content according to the importance and emphasis defined by the server.

### Step 21:

User reviews recommended packaging resources and decides on purchase.

User checks listed items, examines prices and special price indicators, and selects items to purchase.

Input: displayed resource list and interactive controls on the terminal.

Output: a set of user selections indicating chosen resources and quantities.

Terminal records which buttons the user pressed and which quantities were specified, and prepares purchase instructions.

### Step 22:

Terminal sends purchase instructions to the server.

Terminal composes a request containing the selected resource identifiers and quantities and transmits it to the server.

Input: user selections for resources and quantities.

Output: an HTTP request with structured purchase data and session identifiers.

Terminal ensures that the user's authentication tokens are attached and sends the request to a purchase-processing endpoint.

### Step 23:

Server processes the purchase through the electronic transaction platform.

Server interacts with the transaction interface to create an order for the selected resources.

Input: purchase data containing resource identifiers, quantities, and user shipping details.

Output: order confirmation data including order ID, status, and payment instructions.

Server constructs and submits transaction requests, receives responses from the transaction platform, updates order history tables, and returns a confirmation summary to the terminal.

### Step 24:

Terminal displays purchase confirmation and updates UI.

Terminal receives order confirmation from the server and presents it to the user.

Input: confirmation summary including order ID and payment status.

Output: a confirmation screen and updated state indicating that resources have been ordered.

Terminal may show expected delivery time and a link to view packaging instructions again.

### Step 25:

Server generates and registers detailed diagrams and videos for the packaging method.

Server uses the packaging steps and resource dimensions to generate diagram layouts and video scripts.

Input: packaging steps, selected resources, and product dimensions.

Output: diagram files and video files or generation instructions stored in content storage.

Server computes 2D layouts of boxes and cushioning, feeds diagram specifications to a graphics library to create images, and composes a sequence of frames and captions into a tutorial video, then saves URLs in a content index.

### Step 26:

Terminal retrieves and plays tutorial content when requested by the user.

Terminal downloads or streams the diagrams and videos from the server after the user requests additional guidance.

Input: content URLs and user request events (for example, pressing “Play tutorial”).

Output: on-screen playback of images and videos showing how to apply the packaging steps.

Terminal manages buffering and playback controls, allowing the user to pause, rewind, and repeat critical segments.

### Step 27:

Server records usage history and interaction patterns.

Server collects logs of which content the user viewed, how long videos were watched, and which steps were frequently revisited.

Input: interaction events reported by the terminal (scrolls, pauses, replays, exits).

Output: usage history records stored in a dedicated history table.

Server associates the events with session IDs and product IDs and stores timestamps and event types for later analysis.

### Step 28:

Server updates prompt generation conditions and proposal logic based on histories.

Server periodically analyzes accumulated histories, order outcomes, and emotion labels to refine its templates and selection rules.

Input: history records, order history, and emotion tables.

Output: updated prompt templates, revised scoring weights, and modified selection thresholds.

Server computes statistics such as correlation between detailed instructions and reduced damage reports, adjusts parameters for risk weighting and explanation depth, and writes updated configuration values to configuration storage so that subsequent executions of the program use the improved conditions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

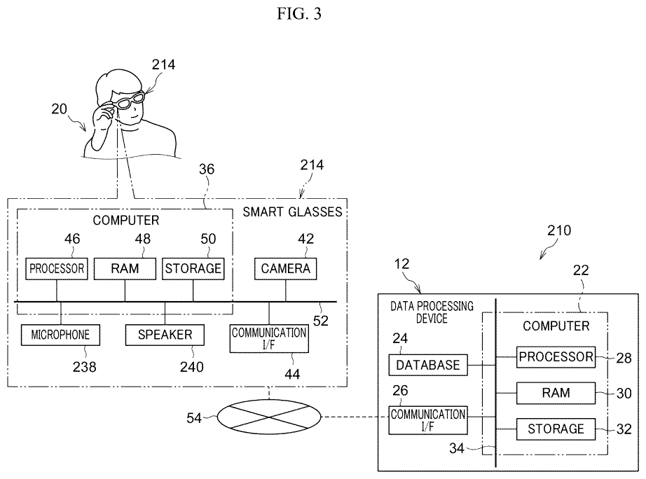

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

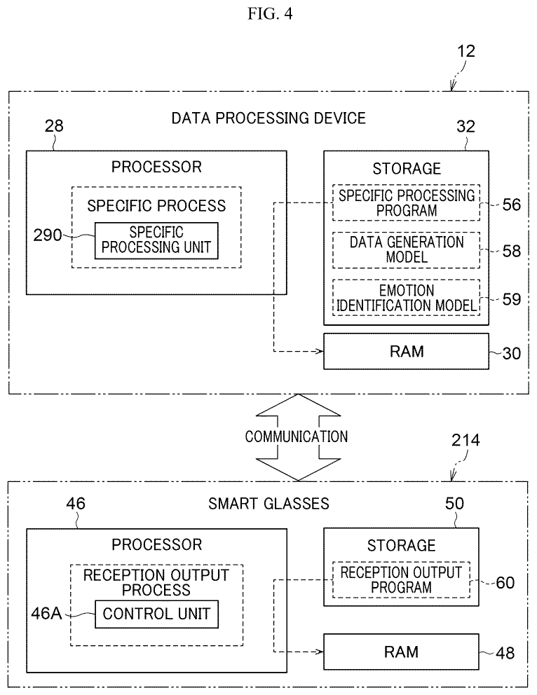

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

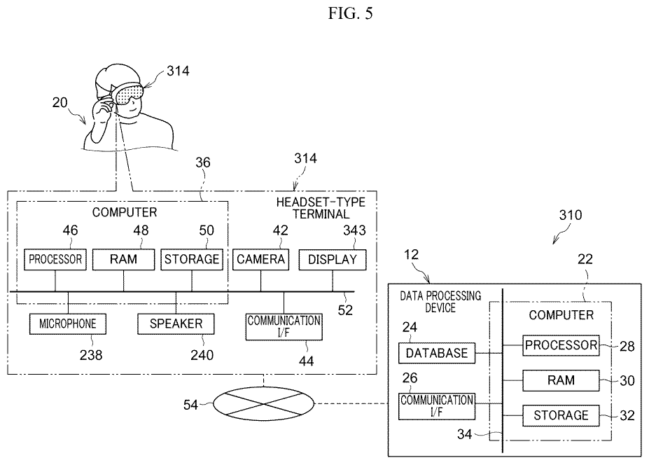

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

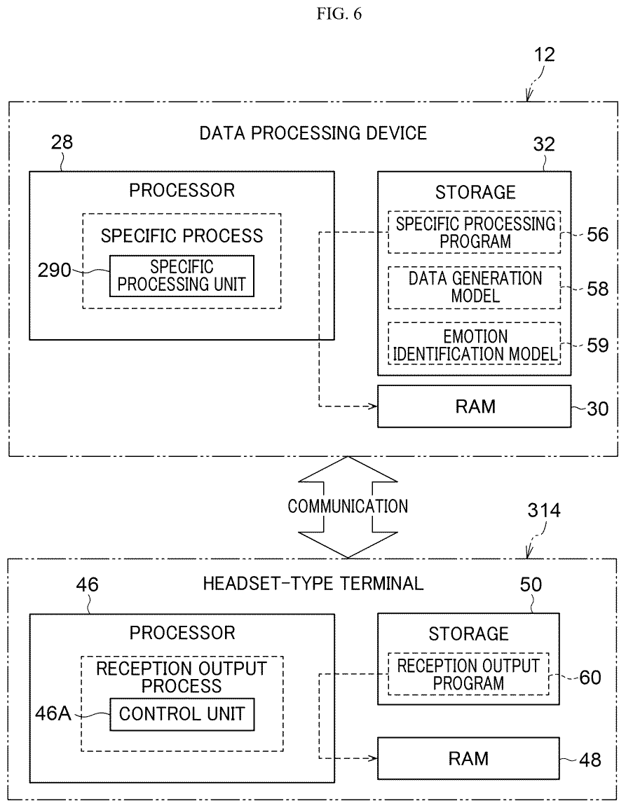

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

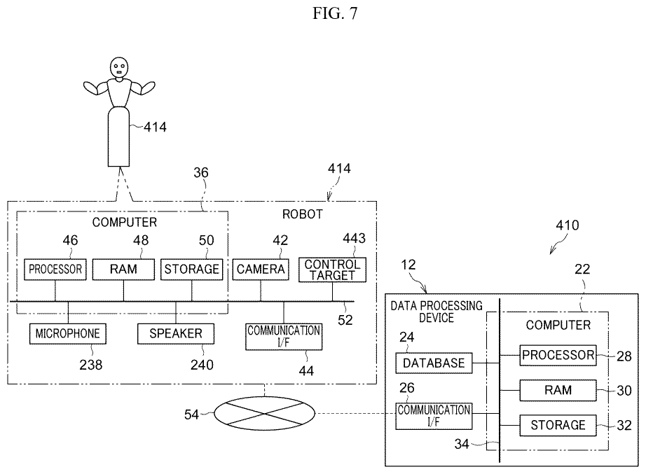

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

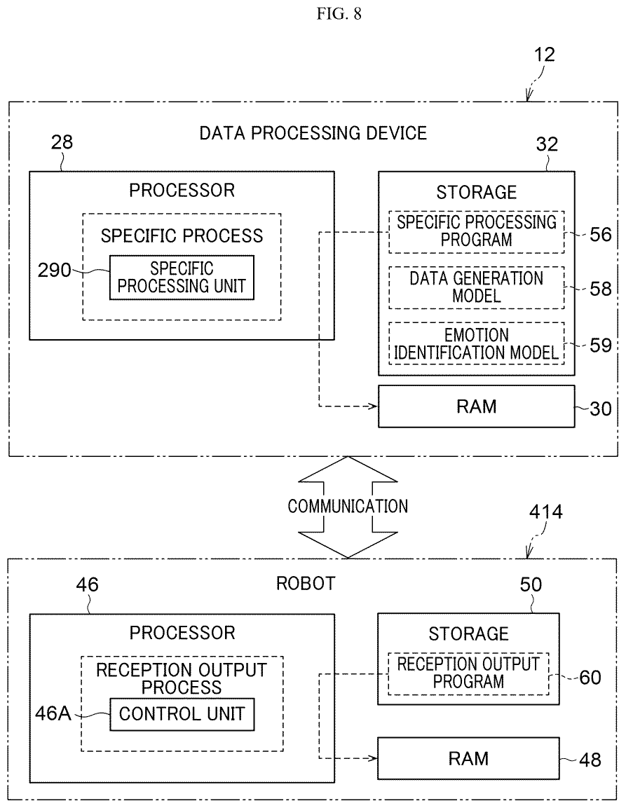

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

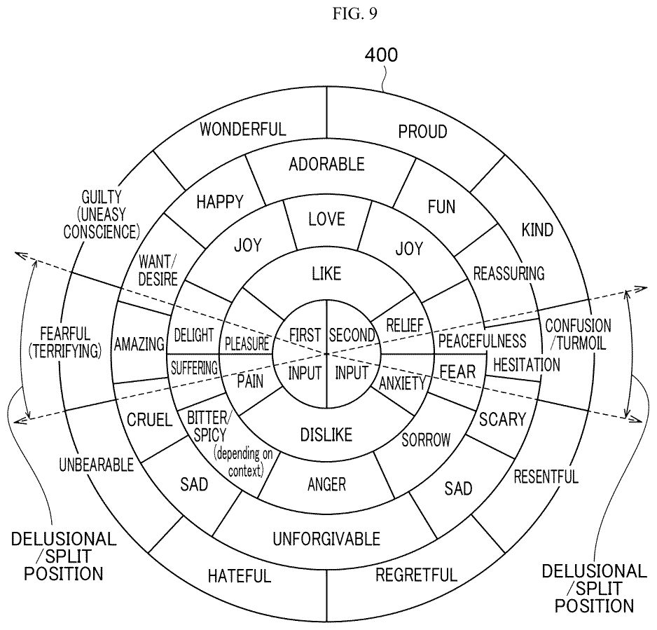

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

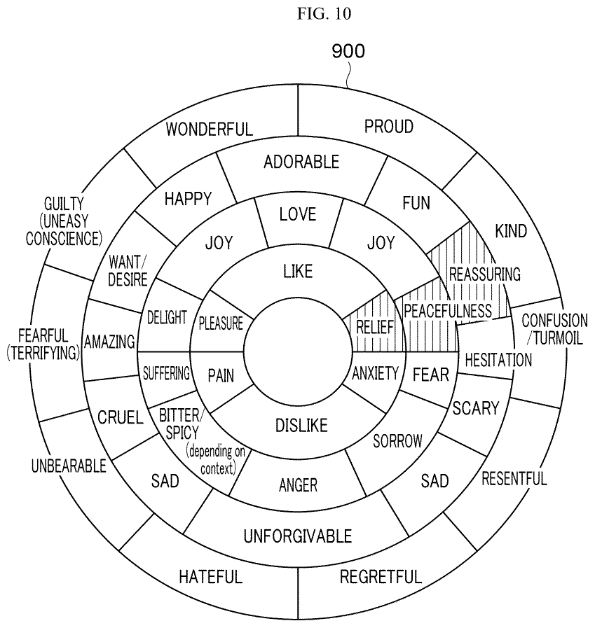

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### (Supplementary 1)

A system comprising a processor,
wherein the processor is configured to
acquire product information including at least product image data from a user terminal via a communication network,
analyze the acquired product information to specify attribute information of a product,
generate structured data of the attribute information of the product by using an image processing information processing unit and a machine learning information processing unit,
generate a prompt sentence, based on the structured data, for causing a generative AI model to propose an optimal packaging procedure,
input the generated prompt sentence into the generative AI model, and obtain response data from the generative AI model, the response data including packaging procedure information and packaging material information,
analyze the obtained packaging material information, normalize types, dimensions, quantities, and performance of packaging materials, and classify the normalized data as packaging material requirement information,
transmit a product search request to an electronic transaction system via the communication network based on the packaging material requirement information, acquire transaction information from the electronic transaction system, select recommended packaging material candidates based on the transaction information, and generate purchase reference information,
select a plurality of visual information elements corresponding to respective steps of a packaging operation based on the packaging procedure information and the recommended packaging material candidates, and generate packaging guide information for visually presenting the packaging operation by editing and composing the visual information elements using the image processing information processing unit and a video editing information processing unit, and transmit the packaging guide information and the purchase reference information to the user terminal so as to enable presentation of the packaging procedure information, the recommended packaging material candidates, and the packaging guide information on the user terminal.

### (Supplementary 2)

The system according to supplementary 1,
wherein the processor is configured to
acquire user condition information and user evaluation information from the user terminal, add the user condition information and the user evaluation information to the structured data, and dynamically adjust content and structure of the prompt sentence based on the user condition information and the user evaluation information so that the packaging procedure information and the packaging material information output from the generative AI model are updatable.

### (Supplementary 3)

The system according to supplementary 1,
wherein the processor is configured to
include, in the prompt sentence, at least one detailed item of the attribute information of the product, the detailed item including at least one of a product category, a shape, a dimension class, a mass class, a material class, and a damage risk level, and define a format and information items of the prompt sentence such that the generative AI model derives the packaging procedure information and the packaging material information based on the detailed item.

### Application Example 1

### (Supplementary 1)

A system comprising a processor,
wherein the processor is configured to
acquire product image data,
transmit the product image data to an image analysis processing apparatus and specify product characteristic information including at least a product type, a material, a size category, and a damage risk level based on an analysis result obtained from the image analysis processing apparatus,
generate a prompt sentence, based on the product characteristic information and delivery condition information, for instructing a generative information processing model to propose an optimal packaging procedure and a required packaging material configuration,
input the generated prompt sentence into the generative information processing model and obtain response information including the packaging procedure and the packaging material configuration from the generative information processing model,
extract packaging material types and quantity information from the response information, and select a recommended packaging material set by associating the packaging material types with merchandise identification information in a material sales electronic transaction system,
acquire transaction information of the material sales electronic transaction system for the recommended packaging material set, generate purchase screen information including special price information, provide the purchase screen information to a user terminal, and enable an execution of a purchase process for packaging materials via the material sales electronic transaction system based on a purchase instruction from the user terminal,
generate packaging guide information including visual content and/or audio content indicating work contents and used materials for respective steps, based on the packaging procedure obtained from the generative information processing model and packaging material information for which the purchase process has been completed, and
transmit the packaging guide information to the user terminal so that the packaging guide information is displayed or played back on the user terminal and safe packaging work using the purchased packaging materials is supported.

### (Supplementary 2)

The system according to supplementary 1,
wherein the processor is configured to control the generative information processing model to receive, as feedback information, usage status information of the packaging guide information and evaluation information acquired from a user, and to adjust contents or constituent elements of the prompt sentence so as to improve an accuracy of proposals of the packaging procedure and the packaging material configuration to be generated thereafter.

### (Supplementary 3)

The system according to supplementary 1,
wherein the processor is configured to describe at least a part of the product characteristic information, including the product type, the material, the size category, the damage risk level, and the delivery condition information, in the prompt sentence according to a predetermined format or a structured expression, so that the generative information processing model generates the packaging procedure and the packaging material configuration optimized in accordance with the product characteristic information.

### EXAMPLE 2

### (Supplementary 1)

A system comprising a processor,
wherein the processor is configured to
receive, from a user terminal via a communication network, product-related information acquired by an information processing apparatus, the product-related information including at least dimensional information, mass information, shape information, and destination information regarding an article to be packaged,
generate, on the basis of product attribute information including the product-related information, a prompt sentence for instructing a generative AI model to propose an optimal packaging method for the article, the prompt sentence including the product attribute information in a natural language form,
input the prompt sentence into the generative AI model and obtain response information relating to the packaging method from the generative AI model,
determine, on the basis of the response information, at least one type and quantity of packaging material, and generate packaging material candidate information corresponding to the at least one type and quantity of the packaging material,
acquire, on the basis of the packaging material candidate information, product information relating to the packaging material from a commercial transaction information processing apparatus via a communication network by using an external application programming interface provided by the commercial transaction information processing apparatus,
combine a plurality of packaging materials included in the product information to constitute at least one packaging material set, and generate recommended packaging material set information for each of the at least one packaging material set,
enable an operation for purchasing the packaging material via the commercial transaction information processing apparatus by using purchase identification information included in the recommended packaging material set information,
generate work instruction information for executing the packaging method using purchased packaging materials, the work instruction information being based on the response information and the recommended packaging material set information, and
transmit the work instruction information and the recommended packaging material set information to the user terminal so as to be displayed on the user terminal.

### (Supplementary 2)

The system according to supplementary 1,
wherein the processor is configured to generate the prompt sentence such that the prompt sentence includes, in the natural language form, structured information including at least the dimensional information, the mass information, the shape information, and the destination information regarding the article.

### (Supplementary 3)

The system according to supplementary 1,
wherein the processor is configured to receive evaluation information or feedback information from the user terminal, and to update content of the prompt sentence or input conditions for the generative AI model on the basis of the evaluation information or the feedback information so as to adjust the prompt sentence used for subsequent proposals of the packaging method.

### Application Example 2

### (Supplementary 1)

A system comprising a processor,
wherein the processor is configured to
acquire product information,
acquire product information and product images and extract product attributes based on the product information and the product images,
acquire user information and information regarding an emotional state of a user and analyze the emotional state of the user,
generate a prompt sentence including conditions relating to a packaging method and packaging resources based on the product attributes, the emotional state of the user, and electronic transaction information, and input the prompt sentence to a generative AI model,
analyze a proposal result regarding the packaging method and the packaging resources output from the generative AI model, and collate the proposal result with a packaging resource information storage unit and a transaction information storage unit to select recommended packaging resources in consideration of inventory status and price information,
enable execution of a purchase process for the recommended packaging resources via an information providing unit of an electronic transaction platform,
generate packaging support content including instruction information describing packaging procedures step by step, based on output from the generative AI model and the emotional state of the user,
deliver the packaging support content to a user information terminal and enable display or playback of the packaging support content on the user information terminal,
record an order history of the packaging resources, a usage history of the packaging support content, and the emotional state of the user, and update generation conditions of the prompt sentence and a packaging method proposal logic based on the histories, and
acquire inventory information and special price information of the packaging resources in a logistics facility and support ordering and inventory management of the recommended packaging resources for the logistics facility based on the inventory information and the special price information.

### (Supplementary 2)

The system according to supplementary 1,
wherein the processor is configured to
configure the prompt sentence input to the generative AI model to include detailed attribute information including dimensions, mass, shape, breakage risk, delivery conditions of a product, and the emotional state of the user, and automatically adjust a structure of the prompt sentence based on the histories.

### (Supplementary 3)

The system according to supplementary 1,
wherein the processor is configured to
cause the packaging support content to include explanation text, diagram information, and video information generated based on output from the generative AI model, and dynamically change a detail level of explanation, a display order, and emphasis positions in accordance with the emotional state of the user.

What is claimed is:

1. A system comprising:
circuitry configured to:
acquire, via a communication interface coupled to a packet-switched network, image data of a target object from a terminal device;
analyze the image data using a trained image processing model comprising a convolutional neural network to extract feature maps and generate attribute data of the target object, the attribute data comprising at least a dimensional category, a material classification, a shape classification, and a risk level;
generate, based on the attribute data, a structured prompt data structure encoding the attribute data as natural language descriptors together with constraint conditions, and input the structured prompt data structure into a generative neural network model to obtain response data comprising procedure data specifying an operational procedure and resource specification data specifying resource types and quantity values;
normalize the resource specification data into requirement data, transmit a query based on the requirement data to an external data service via the communication interface, and select matching resource records from response data returned by the external data service based on the requirement data;
generate visual instruction content by compositing, using an image compositing module, visual information elements corresponding to respective steps of the operational procedure with resource identification data derived from the matching resource records; and
transmit, via the communication interface, the visual instruction content and the resource identification data to the terminal device via the packet-switched network.

2. The system according to claim 1, wherein the circuitry is configured to perform object region detection on the image data to identify a bounding region of the target object, crop the image data to the bounding region, and apply the convolutional neural network to the cropped image data to extract the feature maps.

3. The system according to claim 2, wherein the attribute data further comprises a weight estimate derived from the dimensional category and the material classification using a regression model trained on reference data associating image features with physical measurement values.

4. The system according to claim 3, wherein the circuitry is configured to assign probability values across a plurality of attribute categories based on the feature maps, and select attribute values having probability values exceeding a confidence threshold for inclusion in the attribute data.

5. The system according to claim 1, wherein the structured prompt data structure includes predefined fields populated with the natural language descriptors, and the constraint conditions comprise at least one of a cost parameter, a durability requirement parameter, or a dimensional compatibility constraint derived from the attribute data.

6. The system according to claim 5, wherein the generative neural network model generates a plurality of procedure variants in response to the structured prompt data structure, and the circuitry is configured to rank the plurality of procedure variants based on a scoring function incorporating the constraint conditions and select a highest-ranked procedure variant as the procedure data.

7. The system according to claim 6, wherein the circuitry is configured to receive, via the communication interface, feedback data from the terminal device regarding the response data, store the feedback data in association with the structured prompt data structure and the response data in a storage device, and adjust prompt generation parameters based on the stored feedback data for subsequent prompt generation.

8. The system according to claim 7, wherein the circuitry is configured to aggregate feedback data across a plurality of interactions, compute quality metrics for prompt template variants, and select prompt templates having higher quality metrics for subsequent prompt generation.

9. The system according to claim 1, wherein normalizing the resource specification data comprises parsing text segments of the resource specification data to extract resource type identifiers and quantity values, and mapping the resource type identifiers to standardized category codes using a mapping table stored in a storage device.

10. The system according to claim 9, wherein the circuitry is configured to combine a plurality of individual resource records into a resource set, compute an aggregate parameter value for the resource set, and include the aggregate parameter value in the resource identification data transmitted to the terminal device.

11. The system according to claim 1, wherein the visual instruction content comprises at least one of annotated image data, diagram data, or video data generated by the image compositing module and a video editing module, the visual instruction content presenting step-by-step operational guidance synchronized with resource identification for each step of the operational procedure.

12. The system according to claim 11, wherein the circuitry is configured to generate the video data by sequencing a plurality of image frames each depicting a respective step of the operational procedure, overlaying text annotation data identifying resource items used in the respective step, and encoding the sequenced frames into a video data format.

13. The system according to claim 1, wherein the circuitry is configured to receive, via the communication interface, structured input data comprising dimensional values, mass values, shape descriptors, and destination data from the terminal device, and incorporate the structured input data into the attribute data in addition to image-derived attribute data extracted from the image data.

14. The system according to claim 13, wherein the circuitry is configured to receive delivery condition data specifying transportation constraints from the terminal device, and include the delivery condition data as additional constraint conditions in the structured prompt data structure.

15. The system according to claim 1, wherein the circuitry is configured to estimate an emotional state of a user by applying an emotion identification model to at least one of text data or sensor data received from the terminal device, and adjust a detail level, a presentation order, and an emphasis distribution of the visual instruction content based on the estimated emotional state.

16. The system according to claim 1, wherein the circuitry is configured to store, in a storage device, correspondence data associating the structured prompt data structure with the response data and with selection data received from the terminal device, and modify at least one of a prompt generation parameter or a model input parameter based on the stored correspondence data.

17. The system according to claim 1, wherein the circuitry is configured to monitor a processing latency metric associated with the image processing model and the generative neural network model, and to select between a high-resolution analysis mode and a reduced-resolution analysis mode for the image data based on a comparison of the processing latency metric with a latency threshold value.

18. A system comprising:
circuitry configured to:
acquire, via a communication interface coupled to a packet-switched network, image data of a target object from a terminal device;
perform object region detection on the image data to identify a bounding region of the target object, and analyze the image data within the bounding region using a convolutional neural network to extract feature maps and generate attribute data comprising a dimensional category, a material classification, a shape classification, and a risk level;
generate a structured prompt data structure encoding the attribute data as natural language descriptors together with constraint conditions comprising at least a durability requirement parameter and a dimensional compatibility constraint, input the structured prompt data structure into a generative neural network model to obtain response data comprising procedure data and resource specification data, rank a plurality of procedure variants generated by the generative neural network model based on a scoring function, and select a highest-ranked procedure variant;
normalize the resource specification data into requirement data by parsing text segments to extract resource type identifiers and quantity values, transmit a query based on the requirement data to an external data service via the communication interface, and select matching resource records from response data returned by the external data service;
generate visual instruction content comprising at least one of annotated image data, diagram data, or video data by compositing visual information elements corresponding to respective steps of the selected procedure variant with resource identification data derived from the matching resource records; and
transmit the visual instruction content and the resource identification data to the terminal device via the communication interface and the packet-switched network.

19. The system according to claim 18, wherein the circuitry is configured to receive feedback data from the terminal device, store the feedback data in association with the structured prompt data structure and the response data in a storage device, compute quality metrics for prompt template variants based on aggregated feedback data, and select prompt templates having higher quality metrics for subsequent prompt generation.

20. A method comprising:
acquiring, via a communication interface coupled to a packet-switched network, image data of a target object from a terminal device;
analyzing the image data using a trained image processing model comprising a convolutional neural network to extract feature maps and generate attribute data of the target object, the attribute data comprising at least a dimensional category, a material classification, a shape classification, and a risk level;
generating, based on the attribute data, a structured prompt data structure encoding the attribute data as natural language descriptors together with constraint conditions, and inputting the structured prompt data structure into a generative neural network model to obtain response data comprising procedure data specifying an operational procedure and resource specification data specifying resource types and quantity values;
normalizing the resource specification data into requirement data, transmitting a query based on the requirement data to an external data service via the communication interface, and selecting matching resource records from response data returned by the external data service based on the requirement data;
generating visual instruction content by compositing, using an image compositing module, visual information elements corresponding to respective steps of the operational procedure with resource identification data derived from the matching resource records; and
transmitting, via the communication interface, the visual instruction content and the resource identification data to the terminal device via the packet-switched network.
